(19) United States
(12) Patent Application Publication
(10) Pub. No.: US 2026/0010820 A1
(43) Pub. Date: Jan. 8, 2026

(54) DATA AND RESOURCE AWARE AI MODEL STEERING

(71) Applicant: HUAWEI TECHNOLOGIES CO., LTD., SHENZHEN (CN)

(72) Inventors: Mehdi Arashmid AKHAVAIN MOHAMMADI, Kanata (CA); Hesham Gamal Aly Mohamed MOUSSA, Kanata (CA); Maryam HOSSEINI, Kanata (CA); William Carson MCCORMICK, Kanata (CA)

(73) Assignee: HUAWEI TECHNOLOGIES CO., LTD., SHENZHEN (CN)

(21) Appl. No.: 18/762,187

(22) Filed: Jul. 2, 2024

(51) Int. Cl. G06N 20/00

(52) U.S. Cl. CPC G06N 20/00

(57) ABSTRACT

A method and apparatus for supporting training of an AI model at the nodes of a network is provided. The network includes control plane configured to maintain up-to-date current state information for the network, including for each node in the network. The network includes an AI model steering apparatus coupled to the control plane and configured to determine, based on an indication of the AI model and the current state information or portions thereof relevant for training the AI model, and, if obtained, the training parameters, at least one node for training of the AI model using resources and training data available to the node. The AI model steering apparatus may determine a knowledge network topology including a group of candidate nodes for training the AI model and determine a sequence of nodes from the group to form a route for training the AI model.

### CROSS-REFERENCE TO RELATED APPLICATIONS

This is the first application filed for the present disclosure.

### FIELD OF THE INVENTION

The present disclosure pertains to the field of artificial intelligence (AI), and in particular to methods and systems for supporting training of an AI model.

### BACKGROUND

Training of an AI model may involve using data of a number of devices across a network. Network resources, local resources, the ever-growing magnitude of training data, model size and computational cost can impact AI model training and resulting performance of the trained AI model.

Some knowledge sharing algorithms, such as federated learning (FL) or sequential learning, are directed towards training the AI model using data distributed across a large number of devices. FL relies on frequent communication between a centralized server facilitating the AI model training and the devices on which copies of the AI model are trained locally. Any network congestion or downtime can impact FL performance. Merging locally trained AI model copies into a single fully trained AI model at the centralized server can require a considerable amount of storage, computation and communication resources.

Sequential learning involves training the AI model using new data streams. While generally taking into account age of training data, other overlooked data parameters and dynamics such as reliability, relevance, size and quality can contribute to lower training performance and efficiency.

Split learning involves processing some initial layers of the AI model locally on devices and sending the partially trained AI model to a centralized server for training using the remaining layers thereat, thereby facilitating raw data privacy. While potentially reducing traffic use by sending and receiving only some of the layers of the AI model, split learning lacks accountability of network resources which may fluctuate thereby negatively impacting overall model training time. The AI model may further be susceptible to model drifts as local data used for training may change as the model is being trained. Split learning may be unfeasible for more complex AI models where splitting of the neural network may be highly complex, not possible, may introduce privacy concerns or impact the overall training performance.

Centralised AI model training methods rely on sharing data for training, thereby compromising data privacy and potentially lacking accountability of network resources for sharing of large data sets.

Therefore, there is a need for systems and methods for AI model training that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

One or more aspects of disclosure provides for systems, apparatus and methods for training an AI model. The AI model is steered through a network (e.g. a knowledge sharing network) containing multiple node clusters. The different node clusters and node sub-clusters and nodes thereof can train the AI model in sequence. A node cluster and sub-cluster may include one or more associated nodes. Therefore, a node cluster, node sub-cluster, or both, as used herein may refer to a single node, but may also encompass multiple nodes. Likewise, where the term “node” is mentioned herein, the term “node cluster” may be readily substituted, unless context dictates otherwise. The steering is based on a current state of the network and information contained at the nodes, which may change over time. The steering can adapt to changing conditions. Embodiments of systems and methods disclosed herein with regard to nodes in the network are respectively applicable to node clusters in the network.

An aspect of the present disclosure provides a control plane, or one or more associated networked computing apparatus, which performs a variety of tasks, including maintaining up-to-date current state information for the network, including the information for various node clusters, node sub-clusters and nodes in the network. The network may be a knowledge sharing network, for example a network configured for sharing information usable at least in part for training AI models. The current state information for a node cluster, node sub-cluster or a node is indicative of a current capability, such as resource-related capabilities, for training AI models at the node cluster, node sub-cluster or the node, respectively, using resources thereat or available thereto, and characteristics of AI model training data available using or accessible to the node cluster, node sub-cluster, or the node, respectively. The control plane may be configured to carry one or more of: current state information; instructions for training the AI model; and instructions for monitoring training of the AI model. The control plane is configured to repeatedly interact with nodes of the network to maintain up-to-date current state information for the network, including for each node cluster of a plurality of the node clusters in the network.

The current state information, or more particularly the characteristics of AI model training data, can include a type of data available at (or via) the node, node cluster or node sub-cluster; a quality of the data, of one or more types, available at or to the node, node cluster or node sub-cluster for training the AI model; an amount of the data, of one or more types, available at or to the node, node cluster or node sub-cluster for training the AI model; an age of the data, of one or more types, available at or to the node, node cluster or node sub-cluster for training the AI model; a variation over time of one or more of the data (or its quality, amount or age), of one or more types, available at the node, node cluster or node sub-cluster for training the AI model, the type of data, the quality of data, the amount of data, and the age of data, or the like; or a combination thereof. Characteristics such as quality, amount, age and variation over time can be specified for each type of data available. The current state information can indicate or include a reachability of a node, node cluster or node sub-cluster from one or more other nodes, node clusters or node sub-clusters, e.g. whether communication therewith is currently possible. The current state information can indicate or include a visibility of a node, node cluster or node sub-cluster from one or more other nodes, node clusters or node sub-clusters, e.g. whether the former can currently be detected by the latter. The current state information can indicate or include a trustworthiness of the node, node cluster or node sub-cluster with respect to securely training the AI model. This may indicate, for example, one or more of: whether or to what extent a node can be trusted to handle data according to some security or privacy parameters, whether a node can be trusted to not make unauthorized copies of the (e.g., proprietary) AI model in whole or in part, and whether the node can be reasonably relied on to train the AI model to improve the AI model's performance without degrading it thereby adversely impacting use of time and resources. The current state information can indicate or include a sample of data held by one or more of the plurality of nodes, node clusters or node sub-clusters. The data sample can include data accessible to the node, node cluster or node sub-cluster; data generated by the node, node cluster or node sub-cluster, based on the data accessible thereto (e.g., using a generative model or application) or a combination thereof. For example, some of the data at a node can be provided as current state information, to provide a better idea of what type of data is being held. The current state information can, more generally, indicate or include information usable by an AI model steering apparatus for determining a route.

Another aspect of the present disclosure provides an AI model steering apparatus, which may be formed form one or more associated networked computing apparatus. The AI model steering apparatus is also referred to herein as the Model Training Route Computation Module (MTRCM). The apparatus is operatively coupled to the control plane, as described above. The apparatus is configured to receive an indication of an artificial intelligence (AI) model for training (i.e. to be trained) at nodes, node clusters, node sub-clusters, or a combination thereof, in the network. This indication can be the AI model itself or a related notification. The indication may include one or more of an AI model structure, an AI model architecture, an indication of one or more activation functions of the AI model, and training requirements for the AI model. The apparatus may be configured to obtain training requirements for the AI model. The training requirements can be received along with the AI model or as part of the notification, or they can be obtained via a query. The apparatus is configured to obtain some or all of the current state information as already described above with respect to the control plane. The apparatus obtains, from the control plane or an associated database (e.g. networkwide database), at least portions of the current state information for the network which are relevant for training the AI model.

The MTRCM apparatus is further configured, based on at least the indication of the AI model and the portions of the current state information, to determine a route traversing a sequence of the plurality of node clusters, node sub-clusters, nodes, or a combination thereof, of the network. The MTRCM may be configured to determine the route further based on the obtained training requirements in addition to the indication of the AI model and the current state information (e.g., portions thereof). The sequence can include a sequence of node clusters, one or more sequence of node sub-cluster, one or more sequence of nodes of one or more node clusters or node sub-clusters, or a combination thereof. The sequence can include a single or multiple node clusters, a single or multiple node sub-clusters, a single node or multiple nodes, or a combination thereof, for example depending on how often route changes may be required, on the deployment of MTRCM instances in the network, or a combination thereof. Where the MTRCM determined a sequence of node clusters or sub-clusters, the MTRCM or another instance thereof may determine a (e.g., sub) sequence of nodes for each cluster or sub-cluster having more than one associated node. Therefore, MTRCMs can perform routing in a hierarchical architecture model. Each node in the sequence is used in turn for sequential training of the AI model using respective resources and data available to or accessible by that node (either at the node or recruited by the node), as the AI model is forwarded along the route. The apparatus is further configured to cause forwarding of the AI model to a next node, node cluster, or node sub-cluster in the sequence according to the route. The forwarding may be performed via a data plane of the system which carries information such as the AI model itself.

In some implementations, one or more additional instances of the MTRCM may be provided, each operatively coupled to the control plane. The control plane may be configured to distribute information to the MTRCM and the one or more additional instances of the MTRCM.

In some implementations, a second AI model steering apparatus (i.e., a second MTRCM instance) operatively coupled to the control plane may be provided and configured to receive the indication of the AI model for training, obtain, from the control plane or the associated database, further portions of the current state information for the network which are relevant for training the AI model at the plurality of node sub-clusters. The second apparatus may be configured to, based on the indication of the AI model and the further portions of the current state information, determine a sub-route traversing a sequence of the plurality of node sub-clusters, each node sub-cluster in the sequence of the plurality of node sub-clusters to be used in turn for sequential training of the AI model using respective resources and data available thereto, as the AI model is forwarded along the sub-route, and cause forwarding of the AI model to a next node sub-cluster in the sequence of the plurality of node sub-clusters according to the sub-route, the forwarding being via the data plane of the system.

In some implementations, the MTRCM and instances thereof may be implemented in the network centrally (i.e., centralized MTRCM deployed at an orchestrator), regionally at associated regions or node clusters of the network, locally at nodes of the network, or a combination thereof. MTRCMs may be arranged in a hierarchical model, e.g. with one MTRCM directing routing between node clusters and another MTRCM directing routing within such a node cluster. Each node cluster of the plurality of node clusters may be a respective single node of the network or a respective plurality of nodes of the network.

The MTRCM can incorporate the functionalities of the control plane, or operate together with the control plane. A system including both the MTRCM and the control plane is also provided. Furthermore, MTRCM can coexist with one or more additional instances of the MTRCM, which may also be part of the system. In some embodiments, in a distributed implementation, some or all nodes may include an instance of the MTRCM. The control plane may be configured to distribute information (e.g. current state information) to all the MTRCM instances.

In some implementations, the indication of the AI model includes one or more of: a model structure; a model architecture; an indication of one or more activation functions of the model; and training requirements for the AI model. The indication of the AI model may thus generally define the AI model, its functions and their interrelations, as they presently exist during training, as will be readily understood by a worker skilled in the art.

In some implementations, the MTRCM is configured to determine a knowledge network topology for use in training the AI model. The determination can be made based on information such as the indication of the AI model, the training requirements if such are obtained, and the current state information. The knowledge network topology may indicate at least candidate nodes, node clusters, node sub-clusters, or a combination thereof, of the network which are useful in training the AI model. The knowledge network topology may indicate interconnections between at least the indicated nodes, node clusters, node sub-clusters, or a combination thereof. The interconnections may indicate significance of relationships between data at the indicated nodes, node clusters, node sub-clusters, or a combination thereof. The significance and the relationships is specific to training for the AI model, for example as specified by the indication of the AI model (e.g. indicated requirements and objectives). The nodes may be included in the knowledge network topology based on node characteristics (e.g. data available at nodes) and the relevance thereof in training the AI model. The interconnections may be determined based on data at different nodes. For example, when data at two nodes is correlated and useful collectively in training the AI model, a strong interconnection can be defined between these two nodes. When data at two nodes is unrelated or highly redundant (and therefore less useful as a collective), a weaker or no interconnection can be defined between these two nodes.

In some implementations, the MTRCM can not only direct the AI model between nodes, node cluster, node sub-clusters, or a combination thereof, but can also direct training data to move therebetween, to meet the AI model at a particular node, node cluster, node sub-clusters, or a combination thereof, for use in training. Accordingly, in some embodiments, the MTRCM can determine a requirement for one of the nodes, node clusters, node sub-clusters, or a combination thereof, in the sequence to use specified data, currently unavailable thereat, for training the AI model. The MTRCM can then cause another node, another node cluster, another node sub-clusters, or a combination thereof, of the network to forward the specified data to said one of the nodes, node clusters, node sub-clusters, or a combination thereof, in the sequence, in time for the latter to train the AI model using the specified data.

In some implementations, a node can, autonomously or under direction of a MTRCM, recruit other nodes to participate in training. For example, a node can send the AI model to another node along with training instructions, and receive the AI model back following training. Such actions can be regarded as training by the node, or as an aspect of the AI model routing as performed by the MTRCM.

In some implementations, the current state information is maintained and kept up to date in a database (e.g. the networkwide database). The database may be local to or remote from a network node or computing device at which the apparatus is located. The database may be updated at regular (e.g., scheduled) intervals, in response to an update request (e.g., by the MTRCM), in response to receiving an indication of AI model for training, or a combination thereof. The database may be centralized or distributed. The database can include multiple copies, e.g. one copy per node, node cluster, node sub-cluster, or a combination thereof, having an associated MTRCM. The copies can be synchronized with one another. An MTRCM can query such a local or remote database to obtain the relevant current state information.

In some implementations, as mentioned above, the sequence includes one node or one node cluster. Thus, the MTRCM determines or selects a single next node (or next node cluster) to which to send the AI model. At the next node, the MTRCM or another MTRCM (e.g. local to the next node) can determine another next node, or sequence of next nodes, to which to send the AI model for further training, if required. The AI model can thus be steered in a hop-by-hop manner. In some embodiments, the sequence includes multiple nodes, node clusters, or node sub-clusters. The AI model can be routed to each of these next nodes, node clusters, or node sub-clusters for sequential training thereby. In various embodiments, a number of nodes, node clusters, node sub-clusters, or a combination thereof in the sequence can be configured based at least in part on a rate of change of the current state information. For example, if current state information is changing rapidly, the sequence can include correspondingly fewer nodes, node clusters, node sub-clusters, or a combination thereof. This allows AI model steering to adapt to dynamics of the network. Therefore, the sequence may include the sequence includes one node cluster or multiple node clusters, a number of node clusters in the sequence being configured based at least in part on a rate of change of the current state information.

In some implementations, following training at a last node, node clusters, node sub-clusters, or a combination thereof in the sequence, the MTRCM or another instance of the MTRCM may determine a further sequence of nodes, node clusters, node sub-clusters, or a combination thereof to be used in further training of the AI model. A sequence (e.g. information indicative thereof) including multiple nodes, node clusters, node sub-clusters, or a combination thereof, may be forwarded to the next node, node cluster, or node sub-cluster in the sequence along with the AI model and used to direct further forwarding of the AI model through the multiple nodes, node clusters, node sub-clusters, or a combination thereof, in turn for training thereat. Alternatively, an MTRCM can declare training to be complete. The further training or declaration can be based at least in part on an evaluation of the AI model. The MTRCM may be configured to perform an evaluation, based on the rate of change of the current state information, the current performance of the AI model, or both. The rate of change may indicate whether training data is significantly changed, renewed or updated since the preceding determining of the route traversing the sequence of node clusters or nodes thereof. The evaluation may determine whether further training may result in further improving the performance of the AI model. Upon determining that further training may improve performance above a predefined level, the MTRCM may proceed by determining a further sequence of node clusters or nodes and select at least one node for further training the AI model. Upon determining that further training may improve performance below the predefined level, the MTRCM may proceed to terminate training of the AI model.

In some implementations, when the sequence includes multiple nodes, an indication of the sequence is forwarded along with the AI model and is used to direct further forwarding of the AI model through the multiple nodes in turn for training thereat. This allows the sequence to be used to guide the AI model at multiple nodes. This approach may be useful for example when the current state information is unchanging or changes at a relatively low rate.

In some implementations, the MTRCM is configured to receive performance evaluation information indicative of a current performance of the AI model. The MTRCM can then determine or reconfigure the route based at least in part on the performance evaluation information. The MTRCM can direct the model toward a performance evaluation module and request the performance evaluation information from such a module. Alternatively, the MTRCM can perform the performance evaluation, or another node can direct performance or perform the performance evaluation. This allows the MTRCM to adapt AI model training based on performance feedback, or to declare the training complete when performance is sufficient.

Accordingly, in various embodiments, the MTRCM is configured to instruct one or more of the nodes to initiate an evaluation of current performance of the AI model, e.g. by invoking a performance evaluation module, and to adjust further training of the AI model based on results of the evaluation.

In some implementations, when the current state information is time-varying, the MTRCM is configured to monitor variations in the current state information and to adjust the route in response to such variations. In some cases, the MTRCM can recompute and update the route even before the AI model has finished traversing the route. The MTRCM may make route adjustments based on new information arriving from the control plane. In some embodiments, the MTRCM, in response to such new information, may construct a new topology or update the existing topology. Based on the route adjustments, the MTRCM can identify at least the next node, and possibly the series of next nodes, to which to send the AI model, which may have changed relative to previous determinations due to the new current state information.

In some implementations, the MTRCM is configured to determine and specify hyperparameters for use in training the AI model at one or more of the plurality of node clusters. The hyperparameters can include, for example, learning rate, batch size, number of epochs of the training, optimization settings, loss function(s), model architecture(s), regularization, initialization, learning rate schedule, validation split, etc. The hyperparameters may be used to guide the AI model training in general.

As noted above, an MTRCM can guide AI models on behalf of multiple node clusters, in a centralized or partially centralized configuration. Accordingly, the MTRCM may be separate from some or all of the plurality of node clusters which receive the AI model. Alternatively, multiple MTRCMs can be provided, for example one at each node, in a distributed configuration. Accordingly the MTRCM may be deployed at one of the plurality of node clusters which receives the AI model.

Another aspect of the present disclosure provides a method performed by an apparatus or collection of apparatuses in a network, such as a knowledge sharing network. The apparatus can be a networked computing device, or collection of such devices. The method includes receiving an indication of an artificial intelligence (AI) model for training at nodes in the network. The method may include obtaining training requirements for the AI model. The method includes obtaining current state information for the network, including for each node of a plurality of the nodes in the network, the current state information indicative of a current capability for training the AI model at the node, the current state information indicative of characteristics of AI model training data available using the node. The current state information can be determined by a control plane entity. The method includes, based on the indication of the AI model (e.g. structure, architecture, activation functions, etc.) and the current state information, determining a route traversing a sequence of the plurality of nodes, each node in the sequence to be used in turn for sequential training of the AI model using respective resources and data available thereto, as the AI model is forwarded along the route. The method may include obtaining training requirements for the AI model and determining the route further based on obtained training requirements in addition to the indication of the AI model and the current state information (e.g., portions thereof). The sequence can include a sequence of node clusters, one or more sequence of nodes of one or more node clusters, or a combination thereof. The method includes causing forwarding of the AI model to a next node cluster or next node in the sequence according to the route.

Other aspects of the method may also be provided for, for example commensurate with aspects of the MTRCM apparatus or system as already described above.

Other embodiments may include a computer program or computer program product which may include a (e.g. non-transitory) computer readable medium. The computer program, computer program product, or computer readable medium may contain statements and instructions which, when executed by a computer, cause the computer to perform the method as described above. Other embodiments may include an apparatus for implementing the above-described method.

In some implementations, the control plane, MTRCM, or both, each include at least processing electronics (e.g. a computer processor or other digital or analog electronics), a communication interface or network interface, and memory. In various embodiments, the control plane, MTRCM, or both, may include one or more functional modules configured to perform the various recited operations of these devices.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1A shows a schematic of a network, according to embodiments of the present disclosure.

FIG. 1B shows a model training route computation module (MTRCM) in communication with network nodes, according to an example of the present disclosure.

FIG. 1C shows an example of a network having MTRCM instances implemented at network nodes, according to an example of the present disclosure.

FIG. 1D shows an example of a network having locally and regionally implemented MTRCM instances, according to an example of the present disclosure.

FIG. 2 shows the MTRCM determining a knowledge network topology including a group of nodes for training an AI model using a database, according to an example of the present disclosure.

FIG. 3 shows the MTRCM determining a knowledge network topology including a group of nodes for training an AI model using a networkwide current state topology, according to an example of the present disclosure.

FIG. 4 schematically illustrates a training route for training an AI model, according to an example of the present disclosure.

FIG. 5 schematically illustrates a training route for training an AI model, according to another example of the present disclosure.

FIG. 6 shows a flowchart of a method for training an AI model, according to an example of the present disclosure.

FIG. 7 shows a flowchart of a method for training an AI model, according to another example of the present disclosure.

FIG. 8 shows a schematic illustration of a system including a database, a control plane device and an MTRCM device, according to examples of the present disclosure.

FIG. 9 shows a schematic illustration of an electronic device that may perform any or all of operations of the methods and features explicitly or implicitly described herein, according to examples of the present disclosure.

It will be noted that throughout the appended drawings, like features are identified by like reference numerals.

### DETAILED DESCRIPTION

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The phrase “in embodiments” can be interpreted to mean “in one or more, but not necessarily all embodiments.”

In embodiments, a system for supporting artificial intelligence (AI) model training using a network is provided and includes a control plane and an AI model steering apparatus, also referred to herein as a model training route computation module (MTRCM) implemented in the network. The MTRCM is configured to steer (e.g., direct, route, manage, oversee) training of an AI model at selected nodes of the network taking into account current state information for the network including for each node in the network, an indication of the AI model, and, where applicable, training requirements for the AI model and other considerations, such as overall training associated load on the nodes, the control plane, the MTRCM, or a combination thereof.

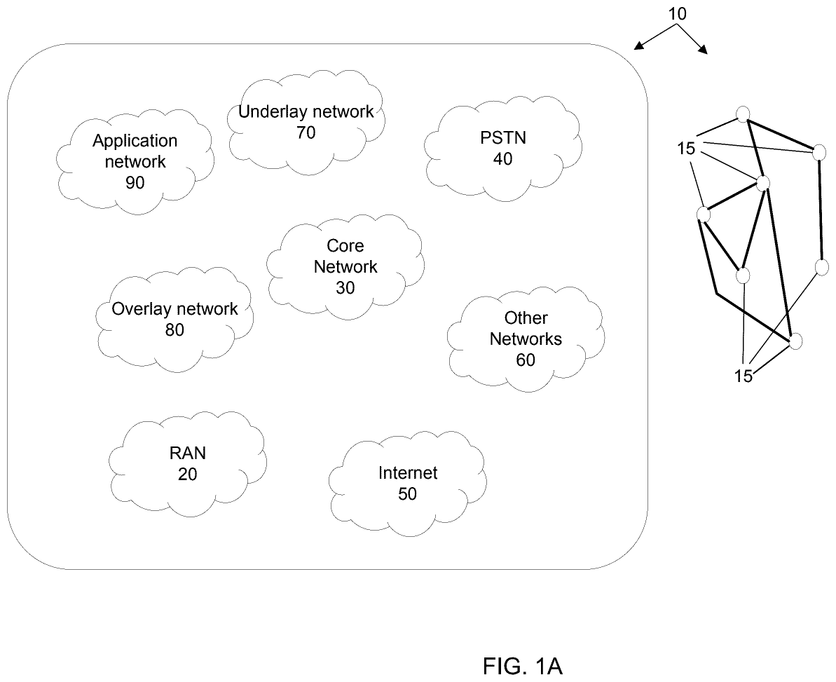

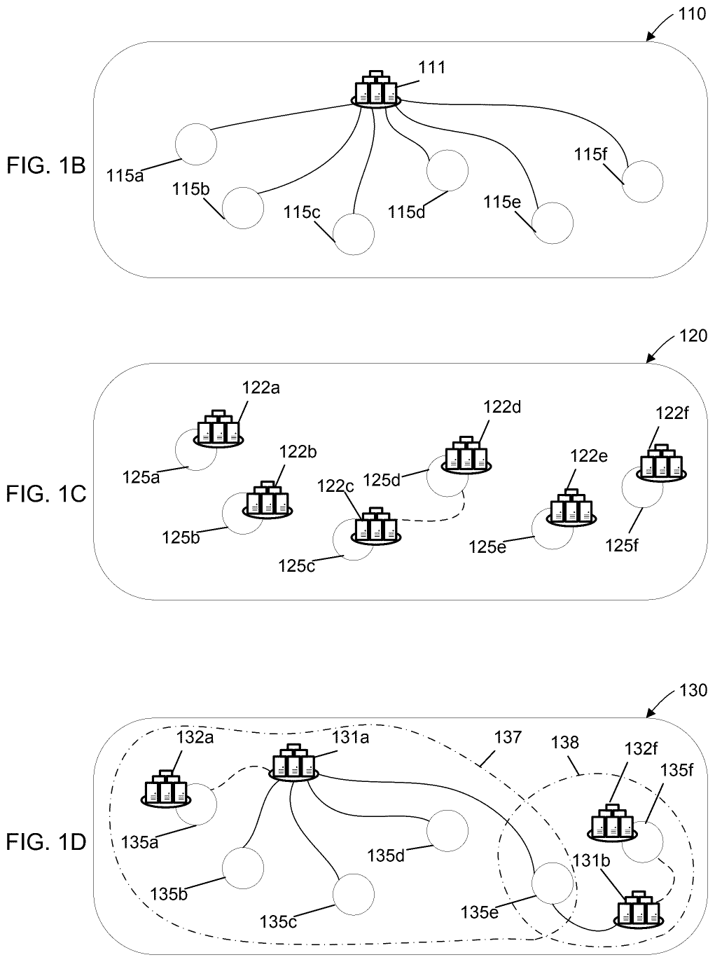

FIG. 1A schematically illustrates a network 10, according to embodiments. The network 10 may be or may include a knowledge sharing network, for example a network configured for sharing information usable at least in part for training AI models. The network includes nodes that carry data, also referred to herein as training data, that can be used to train an AI model. The data (e.g., access to data) may be held across multiple nodes and collectively form a global knowledge dataset for AI model training. Therefore, in a knowledge sharing network, the data can be held across multiple nodes to form a global, cumulative dataset. The AI model can then move between the nodes to learn from local data of each node. The network 10 may include an underlay network 70, such as a transport network. The network may include an overlay network 80, such as a mobile network. The network may include an application-driven network 90. The network may include a radio access network (RAN) 20. The RAN 20 may be a next generation (e.g., 6^{th} generation (6G) or later) radio access network, or a legacy (e.g., 5^{th} generation (5G), 4^{th} generation (4G), 3th generation (3G) or 2^{nd} generation (2G)) radio access network. In some implementations, the 6G radio access refers to a next generation air interface of standards which may comprise both terrestrial networks (TNs) and non-terrestrial networks (NTNs). The network 10 may include a core network (CN) 30 that may be dependent or independent of the radio access technology used in the network. The network 10 may include a public switched telephone network (PSTN) 40, the internet 50, and other networks 60. In general, the network enables communication of multiple wireless or wired devices thereof, such as nodes, network elements, servers, databases, switches, routers, orchestrator, etc. Devices having access to training data, resources for training an AI model, or both, are network nodes as referred to herein. As also illustrated, the network 10 includes nodes 15, which may include information and resources for use in training AI models. The nodes are interconnected by communication links. These nodes form the parts of the knowledge sharing network. Some or all of the nodes 15 can also include an MTRCM, or data plane apparatus, database apparatus, or a combination thereof.

The network may provide content, such as voice, data, video, text, or a combination thereof, via broadcast, multicast, groupcast, unicast, etc. The network may operate by sharing resources, such as carrier spectrum bandwidth, among its constituent elements. The network may provide a wide range of communication services and applications to network users including enhanced Mobile Broadband (eMBB) services, ultra-reliable low-latency communication (URLLC) services, massive machine type communication (mMTC) services, integrated sensing and communication (ISAC), immersive communication, massive communication, Hyper reliable and low-latency communication, ubiquitous connectivity, integrated AI and communication, and other services that can be provided by a future generation communication system. The network may provide other services and applications such as earth monitoring, remote sensing, passive sensing and positioning, navigation and tracking, autonomous delivery and mobility, etc.

The network may include a terrestrial network, a non-terrestrial network, or a combination thereof. The network may provide a high degree of availability and robustness through a joint operation of a terrestrial network and a non-terrestrial network. For example, integrating a non-terrestrial network (or components thereof) into a terrestrial network can result in a heterogeneous network comprising multiple layers. The heterogeneous network may achieve better overall performance through efficient multi-link joint operation, more flexible functionality sharing, and faster physical layer link switching between terrestrial networks and non-terrestrial networks. The terrestrial network and the non-terrestrial network could be considered sub-systems of the network.

The network may be compliant with one or more regional, national, international, or a combination thereof, standards, such as the Internet Engineering Task Force (IETF), the European Telecommunications Standards Institute (ETSI™), and the 3^{rd} Generation Partnership Project (3GPP™).

The network includes a plurality of node clusters. Each cluster includes at least one node associated thereto. The nodes may include (e.g. mobile) user devices, edge devices, physical devices, virtual devices, network elements, servers, ground stations, base stations, etc., that have access to training data for training at least one AI model, access to resources for training at least one AI model, or a combination thereof. The network and each node of the network can be characterized by current state information indicative of at least one (e.g., static, dynamic, or a combination thereof) respective current state metric or attribute, described elsewhere herein.

In embodiments, node clusters of the network and associated nodes thereof have access to data for training an AI model, resources for training the AI model, or both. The training data may be at the node. The training data or access thereto may be sharable among the nodes of a node cluster. The training data may be associated with a node, for example being on a cloud storage device used by the node. Access to training data of a first node cluster or a first node may be provided to a second node cluster or a second, respectively, that is correspondingly authorized to access (e.g., receive, use, copy) the training data of the first node cluster or the first node, respectively. Such authorized access to training data may be advantageously provided (e.g., obtained upon corresponding request and permission), for example in response to determining that the first node cluster has insufficient resources (or insufficient training data), either thereat or accessible thereto, for training the AI model. The first node cluster may share (e.g., all or a portion of) its respective training data, or share its access thereto, with the second node cluster. The second node cluster may use the (e.g., all or a portion of shared) data of the first node cluster for training the AI model at the second node cluster. The MTRCM may determine the requirement for the second node cluster to use the data, and direct (e.g. via control plane) the first node cluster to forward (e.g. via data plane) the data to the second node cluster at an appropriate time, to enable remote access to the data of the first node cluster to the second node cluster at an appropriate time, or a combination thereof.

In embodiments, at least one node cluster may be a node of the network or a respective plurality of nodes of the network. One or more node cluster may include a single associated node. In a particular non-limiting example, each node cluster of the network may include an associated single node, such that node cluster and associated nodes of the network have a one-to-one correlation. Nodes associated with a node cluster may be fixed or adjustable. For example, nodes may be added to or removed from a cluster in response to such nodes moving or leaving the network, or joining the network, respectively. Deployment/organization of node clusters may be based on MTRCM deployment or may be independent of MTRCM deployment. In one particular example, there could be one cluster comprising all nodes of the network and the MTRCM could be implemented centrally at/as an orchestrator for such cluster. In another example, the network could include a plurality of node clusters corresponding to the plurality of nodes of the network where each cluster has a single corresponding node and MTRCM instance local to the node and, therefore, local to each cluster.

The current state information for each node cluster may include current state information for each node associated with the cluster.

In embodiments, methods and system described herein in relation to node clusters apply to associated nodes of node clusters.

In embodiments, the AI model may be any one of: an artificial intelligence model, a neural network model, a machine learning model, a generative AI model, a large language model, or any other model (e.g. a mathematical model, a random forest) that requires training on training data accessible to nodes to achieve a certain intended training objective.

A number of AI models may be trained consecutively, concurrently, or a combination thereof, at a network node. The AI models may be of same or different type and may use same, different or overlapping training data accessible to the node. Each AI model may have respective training requirements that include at least one training requirement. Non-limiting examples of a training requirement include a target key performance indicator (KPI), a target performance metric value, a target performance criterion, a convergence constraint, an accuracy constraint, a loss constraint, a data type constraint, a data reliability constraint, a data size constraint, a data age constraint, a training time constraint, a generalization constraint, a scalability constraint, any other training constraint as understood by a person skilled in the art, or a combination thereof. A training requirement may be provided by a client or user providing an AI model, an indication thereof, or both, for training. A training requirement may be provided by an application or an AI model owner providing the AI model, the indication thereof, or both, for training. The training requirement may generally indicate what task(s) the AI model is to be trained for. A training requirement may be obtained (e.g., received, determined) by an MTRCM in accordance with the AI model or the indication thereof. A training requirement may be a default training requirement. A training requirement may be a selectable training requirement. A training requirement may be a flexible training requirement that may be adjustable, for example, in response to reaching a predefined training time threshold (e.g., an accuracy requirement may be adjustably lowered if AI model training takes longer than a predefined time, a convergence time requirement may be adjustably lowered if the AI model being trained converges at a slower rate than expected).

In some embodiments, an AI model may not have specific training requirements. In such cases, the training may be based on the AI model indication, the current state information, and, for example, resources, data, training time, or a combination thereof, available or allocated by the MTRCM for training the AI model without reaching any specific training requirement.

In some embodiments, one or more training requirement may be obtained while the AI model is being trained. For example, a client providing the AI model for training and monitoring its training progress may submit one or more training requirement in response to receiving a training status update. The MTRCM may be configured to receive such training requirements during training of the AI model and adjust training of the AI model accordingly, for example, by updating a knowledge network topology for the AI model, updating the route traversing a sequence of nodes selected for training the AI model, or a combination thereof.

In embodiments, some or all obtained (e.g., provided, determined) training requirements of the AI model may be used in determining a knowledge network topology including a group of (i.e., candidate) nodes for training the AI model and training data relationships between nodes of the group. That is, using the training requirement, certain nodes can be selected for use in training, based in part on the data held at the nodes, and possibly based on other features such as the nodes' capabilities, accessibility, etc.

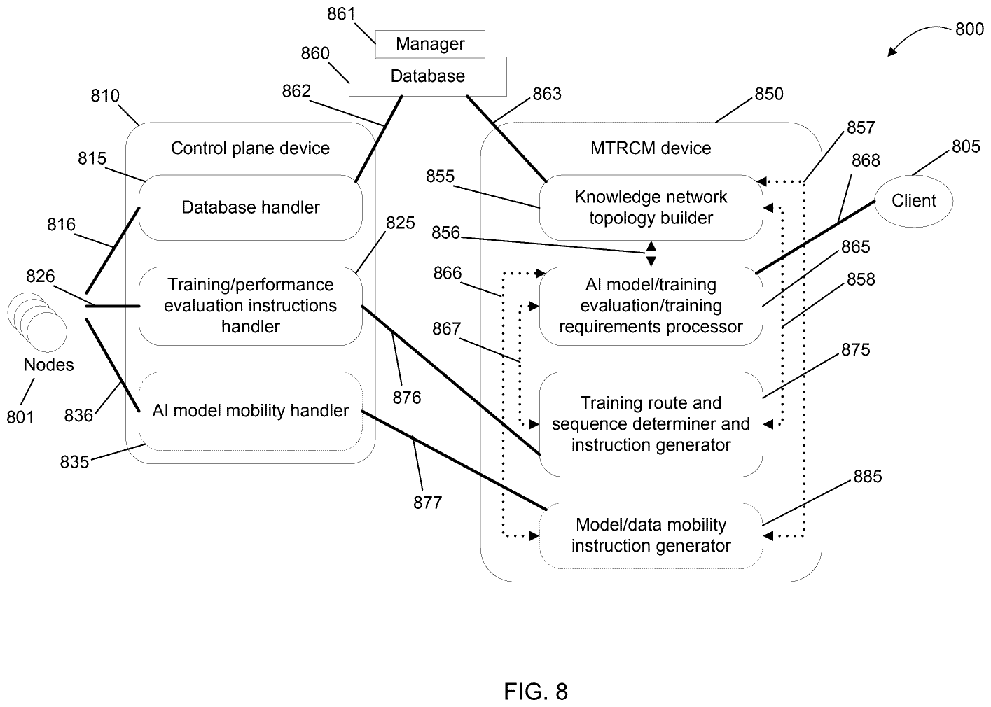

In embodiments, a control plane is implemented in the network and interconnects the nodes of the network, a database of current state information for the network, and the MTRCM (and, where implemented, any instance thereof). The control plane may include or be coupled to a communicative interconnection portion, referred to as a control channel. The control plane may include computing portions, described elsewhere herein, for example with reference to FIG. 8, also, for use in controlling operations, gathering data from network nodes, storing the data (e.g. in a database), etc. The control plane may include a plurality or termination points each coupled to an interface at a corresponding node in the network and configured to receive information provided to the node via the control plane and provide it to a suitable internal module of the node, such as a local instance of the MTRCM at the node or a component thereof (e.g., as detailed with reference to FIG. 8).

In embodiments, the deployment of node clusters, association of nodes thereto and, where implemented, regional MTRCM instances thereto, may be based on MTRCM deployment architecture (e.g., local, regional, centralized) or may be independent of MTRCM deployment. In a particular example, there could be one node cluster comprising all nodes of the network and the MTRCM could be implemented centrally at or as an orchestrator for such networkwide node cluster. In another example, the network could include a plurality of node clusters corresponding to the plurality of nodes of the network such that each cluster has a single corresponding node and MTRCM instance local to the node and, therefore, local to each cluster.

In embodiments, the deployment of node clusters and association of nodes thereto may be predetermined, fixed, adjustable, etc. Nodes associated with respective node clusters may be adjusted in response to such nodes moving, leaving a region or the network, entering a region, joining the network, etc. The current state information for a node cluster may include respective current state information for each node of the cluster. A database storing the current state information may store such information for individual nodes, for node clusters, or a combination thereof.

The control plane is configured to provide (e.g., transmit, carry, distribute), to the MTRCM and, where implemented, any instance thereof, information including the current state information for the network representative of the current state of the network and the current state of nodes, as described elsewhere herein. The control plane may communicate with nodes directly, may facilitate communication between nodes while bypassing the MTRCM, or a combination thereof, thereby, for example enabling exchange of instructions and messages related to training data mobility and AI model mobility between nodes. The control plane may distribute this information proactively, via a database which may be queried, upon request, or the like, or a combination thereof. Such information may be communicated via the control channel, for example between the nodes, between nodes and a (e.g., networkwide) database of the current state information, between the MTRCM (i.e., any instance thereof, where applicable) and the nodes, between the MTRCM and the (e.g., networkwide) database, between MTRCM and a networkwide knowledge network topology, etc.).

The control plane may include, be communicatively coupled with, or a combination thereof, the MTRCM and each instance thereof, where applicable. The control plane and control channel are configured to provide access to a (e.g., networkwide) database of the current state information. The control plane and control channel may be configured to transmit or carry instructions (e.g., information, requests, responses, indications) for training the AI model between the nodes of the network, the MTRCM and other components of the network such as nodes, a user or client device requesting AI model training, a user or client device providing an AI model for training, computing devices, network elements, (e.g., networkwide) database, MTRCM instances, a user device requesting AI model training, a performance evaluator module (PEM), a networkwide knowledge network topology, a network controller, a network coordinator, a system manager, etc. Non-limiting examples of instructions related AI model training may include an indication of a determined knowledge network topology, an indication of a determined group of (i.e., candidate) nodes including one or more node for training the AI model, an indication of a sequence of node for training the AI model, an indication of a route traversing the sequence of nodes for training the AI model, an indication of a next or subsequent one or more selected node for training the AI model, an instruction to send the AI model to a next selected node for training, an indication of a sequence of nodes for training the AI model, respective hyperparameters for training the AI model at each of indicated selected one or more node, AI model training performance status request, response, or both, requests for an update of the (e.g., one or more metric of) current state information of a node, an indication to a user device indicative of a training performance status of the AI model, and such.

In embodiments, the control plane is configured to repeatedly interact with nodes of the network to maintain up-to-date current state information for the network, including for each node in the network. The interaction may involve querying the nodes for updated information or configuring the nodes to proactively provide information updates, for example. For each node, the current state information is indicative of at least a current capability (e.g., resources available) for training AI models at the node and characteristics of AI model training data available using the node (e.g., available to the node, accessible to the node). The control plane is configured to distribute information, such as the current state information and AI model training instructions, to the MTRCM and, where implemented, any instance thereof.

In embodiments, the control plane may be configured to carry instructions for training the AI model, instructions for monitoring training of the AI model, or both. Such instructions may include AI model performance evaluation information indicative of a current performance of the AI model being trained. The instructions for monitoring training of the AI model may be used to transmit operation and maintenance (OAM) information, requests, instructions, or a combination thereof. For example, OAM messages may be sent (e.g., to a node, database, network element, an MTRCM instance, a PEM, etc. from e.g., the MTRCM or instance thereof, from a user, etc.) via the control plane to query the status of AI model training, halt training, etc. for a particular AI model.

In embodiments, the control plane may be utilized for distributing current state information including information about (e.g., indicative or representative of) a type of (i.e., training) data accessible to the node, at each node, or a combination thereof, of the network for training the AI model. The current state information may indicate a quality of training data or one or more types available at each node for training the AI model. The current state information may indicate an amount of data of one or more type available at each node for training the AI model. The current state information may indicate an age of data of one or more types available at each node for training the AI model. The current state information may indicate a variation over time of one or more of: data of one or more types available at the node for training the AI model, the type of data, the quality of data, the amount of data, and the age of data. The current state information may indicate a reachability of each node from other nodes of the network, e.g. whether communication with the node is currently possible. The current state information may indicate a visibility of each node to other nodes of the network, e.g. whether the node can currently be detected by other nodes. The current state information may indicate a trustworthiness of each node with respect to securely training the AI model. This may indicate, for example, one or more of: whether or to what extent a node can be trusted to handle data according to some security or privacy parameters, whether a node can be trusted to not make unauthorized copies of the (e.g., proprietary) AI model in whole or in part, whether the node can be reasonably relied on to train the AI model to improve the AI model's performance without degrading it thereby adversely impacting use of time and resources. The current state information may indicate a sample of data held by one or more of the plurality of nodes. The data sample can include data accessible to the node, data generated by the node based on the data accessible to the node (e.g., using a generative model or application) or a combination thereof. For example, some of the data at a node can be provided as current state information, to provide a better idea of what type of data is being held. The current state information can, more generally, indicate information usable by the AI model steering apparatus for determining the route. The data sample may be used for obtaining current performance information for an AI model being trained. More generally, the current state information may indicate any information usable by the AI model steering apparatus for determining the route for training the AI model. The current state information that is transmitted or distributed by the control plane may include information about the nodes' physical resources (e.g. compute, memory, etc.) indicative of capability for training the AI model.

In some embodiments, the control plane described herein may be implemented at an existing control plane or channel of the network, as readily understood by a person skilled in the art, and configured as described herein. In other embodiments, the control plane may be separate from an existing control plane or channel of the network and may be communicatively coupled thereto. The configuration of the control plane is directed at facilitating and supporting training of AI models using data and resources available to nodes of the network. The control plane may enable functionalities of the MTRCM (and any instances thereof, where implemented) disclosed herein, at least by providing the current state information thereto and transmitting any instructions between the MTRCM, nodes, and a database of current state information; enable monitoring of AI model training; enable OAM functionalities; enable monitoring of current performance of AI models being trained, or a combination thereof. More generally, the control plane is at least used for providing any control messages (e.g., instructions, requests, responses, queries, etc.) between network components (e.g., MTRCM and its instances, nodes, node clusters, PEM, orchestrator, database, etc.) coupled to the control plane.

In embodiment, the control plane may include control plane protocols that may be standardized, for facilitating communication between various components coupled thereto.

In embodiments, a data channel, data plane, or both, is implemented in the network. The data channel spans the network and is configured to transmit associated AI model training information (e.g., current state information data, the full AI model being trained, training data, training data datasets, training data samples for AI model performance evaluation, non-control messages and information). The data channel may transmit a control plane payload. The data channel may transmit a payload associated with a monitoring channel described elsewhere herein. The data channel may include data channel protocols that may be standardized, for facilitating transmission of data and payloads between various components coupled thereto.

In some embodiments, the data channel may be implemented at or coupled to an existing data plane or channel of the network, as readily understood by a person skilled in the art, configured as described herein. In other embodiments, the data channel may be separate from an existing data plane or channel of the network. The data plane and the control plane may utilize a same networkwide communication plane while performing their respective functionalities using respective protocols assigned thereto.

In embodiments, the network includes a performance evaluator module (PEM). The network may include a plurality of PEMs or instances thereof. Each PEM may be configured to obtain (e.g., compute, estimate, determine) current performance information for the AI model being trained for example, using a data sample provided by one or more of a node, the MTRCM, and the database; evaluate performance of an AI model against a predetermined performance requirement, such as a KPI, or a combination thereof. The PEM, where so configured may determine if the performance of the AI model meets the predetermined performance requirement, or to what degree performance requirements are currently met with respect to the AI model being trained. Alternatively, the MTRCM may make such a determination. The performance requirement may be or may include one or more key performance indicator (KPI). Each PEM may be deployed at a respective network node, a network element, or a computing device that may be coupled to the control channel, the monitoring channel, or both, for example. The PEM may be implemented centrally, regionally, locally, or a combination thereof. One or more PEMs may be provided in the network.

In order to evaluate the performance of an AI model, the PEM may need a (i.e., evaluation) data sample. In embodiments, the data sample may be provided by one or more of the nodes of a determined group of nodes of the knowledge network topology for training the AI model, for example. The data sample may include some or all of respective training data accessible to one or more such nodes. Some or all of the data of the data sample may be generated by one or more nodes or by the MTRCM, for example, using a generative function or application using the training data accessible to one or more nodes, thereby, at least in part, facilitating privacy of the training data. Some or all of the data of the data sample may include a portion of the training data specifically dedicated (e.g., by the node, by the MTRCM) for evaluating performance of the IA model being trained. Providing the data for the data sample to the PEM (or one or more instance thereof) may require a corresponding data sharing authorization from each node providing the data to the PEM. Obtaining the data sample and providing it to the PEM may be managed (e.g., via corresponding instructions, requests, authorizations) by an MTRCM, for example.

In embodiments, the network may include a monitoring channel or plane deployed thereat. The monitoring plane may be communicatively coupled to and used by the MTRCM (or a node correspondingly instructed by the MTRCM) for monitoring training of the AI model, such as requesting, receiving, or both requesting and receiving AI model performance evaluation information or indication from a PEM. The monitoring plane may be or may include an Operation and Maintenance (OAM) plane. The monitoring plane may include monitoring plane protocols that may be standardized, for facilitating transmission of monitoring information between various components coupled thereto.

The monitoring plane may be implemented for monitoring the training status of the AI model being trained to enable a client providing the AI model for training or requesting training thereof to monitor the training progress. For example, the client may check where the model is being trained at a given time. The client may submit a query via the MTRCM, a node correspondingly instructed or configured by the MTRCM, or a dedicated node, device, or network element specifically configured to function as an interaction point with the client for monitoring the training. Each such apparatus may be configured to receive the client's query, use the monitoring plane to locate the client's AI model being trained and obtain the information in response to the query/The information may be, for example, information identifying a current node the model is being trained at, current performance information for the AI model, estimated time until training completion, history or log of training (e.g., list of nodes the model trained on so far), etc. The monitoring plane may process such queries, using its respective protocols, and provide query responses to the client. Monitoring services provided via the monitoring plane may be used for queries by the client, a system operator, the MTRCM, or any other entity authorized to monitor training progress by submitting queries and receiving corresponding responses.

In embodiments, the MTRCM and, where implemented, any instance thereof, is an AI model steering apparatus operatively coupled to the control plane and implemented in the network. The MTRCM, as referred to herein, includes any instance thereof, unless indicated otherwise. The MTRCM may be implemented at a computing device, which may be a node in the network that receives the AI model and is coupled to the control plane in communication with the network and nodes thereof. The MTRCM may be implemented (e.g. centrally) at a computing device which is separate from nodes that train the AI model. The MTRCM may be implemented at a computing device which is co-located with or part of a network node which also trains the AI model. The computing device may include, have access to, or both include and have access to at least one processor and at least one memory for storing thereon instructions that, when executed by the at least one processor, configure the computing device to perform methods disclosed herein for training an AI model. The computing device may be dedicated exclusively for implementation of the MTRCM thereat or may have another one or more functionality thereat or associated therewith. In an embodiment, the computing device may be a node of the network.

In embodiments, the MTRCM may include an AI component, a machine learning (ML) component, or both. That is, the MTRCM itself may operate at least in part using AI/ML that, at least in part, enables or facilitates performing of one or more of MTRCM's functionalities.

FIG. 1B shows an MTRCM 111 centrally implemented in a network 110, according to an embodiment. The MTRCM is in communication with nodes of the network, such as nodes 115a, 115b, 115c, 115d, 115e and 115f. For clarity, FIG. 1B, as well as other figures and examples herein, illustrate routing between single nodes. However, in embodiments, one or more of the illustrated nodes can be replaced with node clusters having multiple associated nodes.

In embodiments, respective MTRCM instances may be implemented locally at respective network nodes having accessible training data and resources available for AI model training. Multiple instances of the MTRCM may be deployed at corresponding multiple nodes of the network. Some or all of the nodes which are available for AI model training may include a MTRCM.

FIG. 1C shows MTRCM instances 122a, 122b, 122c, 122d, 122e, and 122f implemented locally at nodes 125a, 125b, 125c, 125d, 125e, and 125f, respectively, of a network 120, according to an embodiment. Nodes of the network 120 can be configured, collectively or individually, to exclusively or preferentially communicate with respective local MTRCM instances, thereby limiting associated communication across the network 120 with a non-local instance(s) of the MTRCM (not shown). If a local MTRCM instance, such as MTRCM instance 122d at the node 125d, becomes unusable (e.g., corrupt, outdated, having insufficient resources available to the local MTRCM instance 122d at the node 125d), the node 125d may be configured to communicate with another MTRCM instance, such as the local MTRCM instance 122c at the node 125c. In some embodiments, one or more of the local MTRCM instances illustrated in FIG. 1C may be omitted. One or more of the illustrated nodes can be replaced with node clusters each having multiple associated nodes, each cluster having a respective local MTRCM instance associated thereto and deployed, for example, at a computing device associated with the node cluster or at one of the associated nodes of the node cluster.

In embodiments, a local implementation of an MTRCM instance at a node may require a corresponding authorization, acknowledgment, or a combination thereof from the node. In order to have an MTRCM instance implemented thereat, the node may need to meet predetermined qualification requirements. The qualification requirements may include the node having access to training data and resources for training at least one AI model. The qualification requirements may include the node meeting a predetermined trustworthiness threshold based on one or more of data security and privacy measures at the node, trustworthiness of the node and respective training data, reliability of training data accessible to the node (e.g., being owned by the node, being shared with the node by another node), history of security incidents associated with the node, or a combination thereof.

In embodiments, the MTRCM may be separate from some or all of the node clusters of the network which receive the AI model. A number of computing devices having respective instances of the MTRCM thereat may be deployed in the network. Such implementation of the MTRCM may be advantageous, for example, in large networks, high frequency AI model training scenarios, or a combination thereof. For example, MTRCM computing devices may be deployed in associated regions of the network such that nodes associated with one region of the network may preferentially communicate with a local-most MTRCM computing device, thereby limiting the resource cost associated with transmission of the AI models, instructions, responses, indications, notifications, or a combination thereof, between the local-most MTRCM device(s) and the nodes of the associated region of the network. Associated regions may, although not necessarily, correspond to node clusters such that nodes associated with one region may also be associated with one node cluster.

In frequent (e.g., above a predetermined frequency threshold) AI model training scenarios, it may be advantageous to implement additional one or more MTRCM instance in order to accommodate correspondingly higher computational, communication, resource requirements, or a combination thereof. Such additional MTRCM instances may be implemented, for example, in respective regions of the network where training data, resources, or both, of the associated nodes are frequently utilized for AI model training.

In embodiments, the implementation of the MTRCM in the network may be predetermined and may be adaptable or adjustable in accordance with one or more of the AI model training requirements, constraints or criteria; the frequency of AI model training; rate of change of the current state information for the network, the size of the network, or a combination thereof.

In embodiments, the MTRCM, as referred to herein, includes, where implemented, at least one instance of the MTRCM.

FIG. 1D shows MTRCM instances implemented regionally (or centrally) and locally in the network 130, according to an embodiment. A first regional MTRCM instance 131a is implemented in the associated first region 137 of the network 130 and is configured to communicate preferentially or exclusively with nodes associated with the first region 137, such as nodes 135a, 135b, 135c, and 135d. Node 135a has a local MTRCM instance 132a thereat and may communicate therewith unless the local MTRCM instance 132a is unusable, as described elsewhere herein, in which case the node 135a may communicate with the first regional MTRCM instance 131a.

A second regional MTRCM instance 131b is implemented in the associated second region 138 of the network 130 and is configured to communicate preferentially or exclusively with nodes associated with the second region 138, such as nodes 135e and 135f. Node 135f has a local MTRCM instance 132f thereat and may communicate therewith unless the local MTRCM instance 132f is unavailable, as described elsewhere herein, in which case the node 135f may communicate with the second regional MTRCM instance 131b. One or more of the illustrated nodes can be replaced with node clusters each having multiple associated nodes. Some clusters may have a respective local MTRCM instance associated thereto and deployed, for example, at a computing device associated with the node cluster or at one of the associated nodes of the node cluster.

In addition to being implemented regionally, one or more instance of the MTRCM may include a centralized implementation for communication with all (e.g. authorized) node clusters and nodes of the network. In case of unavailability of any regional or local MTRCM instance, a centralized MTRCM instance may be used for communication with the node cluster and any associated computations, such as determining a knowledge network topology for training the AI model, determining a group of nodes for training an AI model, selecting a node from the group for training the AI model, or a combination thereof.

In embodiments, a node cluster and nodes thereof may be in communication with more than one instance of centrally, regionally, locally implemented MTRCM, or a combination thereof. For example and with reference to FIG. 1D, node 135e may be configured to communicate with the second regional MTRCM instance 131b and with the first regional MTRCM instance 131a. At least for purposes of MTRCM implementation and associating of regions and corresponding nodes therewith, regions of the network may have predetermined fixed, adjustable, overlapping region boundaries, or a combination thereof.

A central or regional MTRCM instance may be utilized, for example, if one or more functionality of the MTRCM is needed (e.g., update the knowledge network topology, update the group of nodes, update training data relationship information of the knowledge network topology, select a next node for training the AI model) while a local MTRCM instance is not available (not implemented) or is unusable (e.g., corrupt, insufficient resources, out of date, being updated, undergoing maintenance) at the node having the AI model thereat. Performing MTRCM functionalities at a regional or central MTRCM instance advantageously enables more resources to be available at the node for any other functionalities and operation thereof.

A local MTRCM instance may be utilized preferentially if it is available and usable and the node having the AI model thereat and the node has corresponding resources available therefor, such as access to a networkwide database (e.g., if knowledge network topology, the group of nodes thereof or data relationships thereof need to be determined, newly-determined or updated, if the AI model needs to be forwarded to a next node for training), for example. Performing MTRCM functionalities locally using the local MTRCM instance advantageously limits costs (e.g. bandwidth resources, time) associated with communication with a regional or central MTRCM instance.

In embodiments, the MTRCM, and where implemented, each MTRCM instance, can obtain, via the control plane, current state information about current state of the network and current state of the nodes, regardless of a particular implementation or deployment of the MTRCM in the network. The information may be obtained from a database, for example, described elsewhere herein.

In various embodiments, the MTRCM instance which is closest to the node currently holding the AI model is the first choice of MTRCM instance to operate to steer the AI model. This MTRCM instance may be co-located with this node.

In embodiments, the communication between an MTRCM instance and a node may be between the MTRCM instance and the node directly or may be between the MTRCM instance and a local MTRCM instance implemented at the node. Non-limiting examples of such communication include transmission of an AI model (e.g., the node receiving the AI model for training thereat from the MTRCM, the MTRCM receiving a trained or partially trained AI model from the node), instructions (e.g., the MTRCM sending an instruction to the node for forwarding the AI model from the node to another node for training, the MTRCM sending an instruction to the node for forwarding the AI to another node for training), requests (e.g., the node sending a request to the MTRCM requesting an indication of a next node for training the AI model in order to forward the AI model thereto), responses (e.g., the node sending an authorization response to the MTRCM or another node for sharing of its respective training data with the other node, the MTRCM sending to the node a response to an AI model training performance evaluation information request), indications (e.g., the node indicating to the MTRCM that the node has insufficient resources available for training the AI model), and notifications (e.g., the node notifying the MTRCM of completion of training of the AI model at the node). An MTRCM may communicate with a node that is differently located from the MTRCM via the control plane, data plane, or a combination thereof.

In embodiments, the MTRCM is configured to determine a group of (i.e., candidate) nodes from the nodes of the network for training the AI model using the current state information, relevant to training of the AI model, obtained via the control plane from the (e.g., networkwide) database, using the networkwide current state topology, or both. The group of nodes may be determined by the MTRCM for each AI model in accordance with the respective indication of the AI model, the respective training requirements for the AI model if such are available, and portions of the current state information for the network which are relevant for training the AI model.

The MTRCM may obtain (e.g., repeatedly), from or via the control plane or an associated database, the current state information or respective portions of the current state information for the network which are relevant for training the (e.g., particular) AI model. For example, the MTRCM may obtain information about network connections, network node clusters, network node resources, network node data contents, etc. The obtained indication of network node data contents may indicate which nodes include data that relates to the AI model indication and training requirements if such are available. The obtained indication of network node resources and network connections may indicate the feasibility of forwarding the AI model to such nodes or clusters associated therewith holding related data and the feasibility of training the AI model at such nodes, for example.

The nodes of the determined group of nodes are candidate nodes that at least have access to some training data, have (e.g., access to) resources available for training the AI model, or both. Each node of the network may have access to a respective (e.g., portion of the) training data, respective resources for training the AI model, or both.

The group of nodes can be used to define a sequence of nodes, and a corresponding route traversing the sequence of nodes. The sequence and route can also be based on the indication of the AI model, the training requirements if such are available, and the portions of the current state information. The sequence can include a single node or multiple nodes to be used in training the AI model in sequence. Following determining the group of (candidate) nodes, a route traversing some or all of the group of nodes can be determined. The route may traverse each of its constituent nodes only once, or some nodes may be traversed more than once. In either case, route defines a sequence of nodes, which identifies the nodes to be traversed, in order of traversal. The route traversing the sequence of node clusters or nodes is determined by the MTRCM for each AI model in accordance with the respective indication of the AI model, the respective training requirements for the AI model if such are available, and portions of the current state information for the network which are relevant for training the AI model.

In embodiments, a first MTRCM instance, such as for example a centralized or regional MTRCM, may determine the route traversing the sequence of node clusters, while a second MTRCM instance, associated with (e.g., local or regional to) a node cluster of such sequence, may determine a sub-route traversing a sequence of node sub-clusters associated with the node cluster for training the AI model. Similarly to the first instance of the MTRCM, the second instance of the MTRCM may determine the sub-route based on the indication of the AI model and obtained further portions of the current state information for the network which are relevant for training the AI model at node sub-clusters associated with the node cluster. Each node sub-cluster in the sequence of node sub-clusters may be used in turn for sequential training of the AI model using respective resources and data available to the node sub-cluster, as the AI model is forwarded along the sub-route. The second MTRCM instance may cause, e.g. directly or by correspondingly configuring nodes of the node sub-cluster, forwarding of the AI model, via the data plane, to a next node sub-cluster in the sequence node sub-clusters according to the sub-route. Therefore, MTRCM may be deployed in the network hierarchically, such that MTRCM instances are associated with respective one or more node clusters, one or more node sub-clusters, one or more nodes, or a combination thereof. MTRCM instances may be configured to determine a group of (i.e., candidate) nodes for training the AI model, a group of (i.e., candidate) node clusters for training the AI model, a group of (i.e., candidate) node sub-clusters for training the AI model, or a combination thereof, and to determine a respective route traversing a corresponding sequence of nodes, node clusters, node sub-clusters, or a combination thereof, respectively.

In embodiments, the MTRCM, a node cluster, or a node having the AI model thereat for training may be configured to determine a requirement for a node in the sequence or training route to use (e.g., specified) training data that is currently unavailable to that node cluster or node, for training the AI model, and cause another node cluster or node to forward the training data or share access to the training data to the node cluster or node in the sequence or route, in time for that node cluster or node to train the AI model using the shared training data. In other words, if the data accessible to a first node fails to satisfy a training data requirement (e.g., no access to required training data), the MTRCM may be configured (or the MTRCM may correspondingly configure or instruct a second node) to provide access to training data accessible to a second node (i.e., that does satisfy the training data requirement) to the first node for training the AI model with the training data accessible to the second node at the first node.

In an embodiment, if the set of resources at a first node fails to satisfy a training requirement, such as a minimum resources requirement, the MTRCM may be configured (or the MTRCM may correspondingly configure or instruct the first node) to provide or share access (e.g., a portion of) training data accessible to the first node to a second node for further training the AI model with the data of the first node at the second node. Nodes having insufficient resources for training the AI model but capable of providing (e.g., sharing) their respective training data or access thereto with other one or more node of the group of nodes may be included in the group of nodes and in the corresponding knowledge network topology. Therefore, some or all of nodes of the group may participate in training the AI model until a current performance of the AI model being trained reaches a predefined training requirement. Each node of the group of nodes has access to respective training data, resources or both data and resources, for training the AI model. Nodes that, for example, do not have access to respective training data but have resources, may cooperate or collaborate (e.g., as being configured or instructed accordingly my the MTRCM) to collectively provide the training data and resources for AI model training.

The respective training data accessible to the node for training the AI model may include data located at the node; data accessible to the node for example, from one or more of a cloud storage, and from another node provided a corresponding authorization is obtained; or a combination thereof. Respective resources available for training the AI model at the node may include one or more of central processing unit (CPU) resources, graphics processing unit (GPU) resources, neural processing unit (NPU) resources, memory resources, storage resources, cloud computing resources, network connectivity resources, parallel computing resources, or a combination thereof. The resources for training the AI model may include a respective set of resources at each node of the network.

In embodiments, the determined group of nodes is included in a (i.e., AI model-specific) knowledge network topology. The knowledge network topology including the group of nodes may be a data, resource availability, and reachability (DRR) topology of nodes of the group. The knowledge network topology may include information indicative of data relationships between respective training data for training the AI model accessible to each node of the group. Data relationships may include, for each pair of nodes of the group, an extent or a level (e.g., expressed as a percentage) of various similarity, dissimilarity, or both similarity and dissimilarity, characteristics between respective (e.g., all or a portion of) training data accessible to each node of the pair for training the AI model. Such characteristics may include data correlations, data causalities, data age, data hierarchy, data dependency, data size, data class distribution, etc. Data relationship information of the group of nodes may be included where available and accessible. Data relationship information can be used by MTRCM to optimize a selection of a particular one or more node from the group for training the AI model, such as an initial node, a next (i.e., subsequent) node, a sequence of nodes, a route traversing a sequence of nodes, or a combination thereof.

In embodiments, the data relationships are determined in accordance with the indication of the AI model and the obtained training requirements for the AI model. For example, an AI model provided for training may include learning about cats through images and the group of nodes is determined by the MTRCM from nodes of the network in accordance with having access to images of cats. For example, only nodes that have access to images of cats may be selected and added to the group of nodes associated with the AI model. Subsequently, factors such as training data relationships, node reachability, availability, trustworthiness, and resources available for training the AI model may be indicated for each node of the group to further narrow down the nodes of the group for selecting particular one or more node from the group for training the AI model. In a non-limiting example, if the AI model requires a storage size of X GB, then nodes that do not have at least X GB of storage for the AI model may be omitted from the group of nodes or may remain in the group but be omitted from being selected for training the AI model. In another non-limiting example, if the AI model is complex and requires substantial computational resources that may be supported only via GPUs, then only the nodes that house GPUs are kept in the group of nodes. Notably, the available storage of GPU availability for particular node may change throughout training of the AI model. Such changes may be reflected accordingly in the database and in turn, via the control plane, in the (e.g., updated) group of nodes for the AI model, thereby current state of a node may change over time and can be taken into account in the AI model training decisions (e.g., determining or updating group of nodes, selecting a node, selecting a sequence of nodes, selecting a route traversing a sequence of the group of nodes) by the MTRCM or an instance thereof.

In embodiments, the indication of the AI model, the obtained training requirements for the AI model, or both, may be used to determine data relationships between the nodes of the group. The data relationships may define or may be used to define importance or priority of visiting a particular node of the group for training the AI model in relation to other nodes of the group. For example, if the AI model requires learning about black cats, then nodes having access to training data of images made up of mostly black cats will have the highest importance or priority while nodes having access to training data of images made up of mostly mix colored cats will have lower importance or priority (e.g., the smaller the portion of black cats on images accessible to a node, the lower Its importance or priority). After determining training data importable or priority for nodes of the group, connections (e.g., representative of data relationships) between those nodes can then be established based on the variety of cats in training data images accessible to nodes. For example, if two nodes have access to images of only black cats but black cat images accessible to one of the nodes are also images of black cats from only one breed, then that node may be assigned a lower priority or importable in relation to the other node. Determining the knowledge network topology, therefore, may be thought of as an overview of the nodes of the group including node status, current state, and training data relationships among the nodes pertinent to selecting a node of the group for training the AI model, and subsequently steering the AI model to the selected node for training. The knowledge network topology may, therefore, be determined in accordance with the incoming AI model architecture (e.g., as part of AI model indication), AI model training requirements, as well as depending on the training data held by the nodes and data relationships therebetween.

In embodiments, the MTRCM (and where utilized, any instance thereof) may be configured to determine a knowledge network topology for use in training the AI model. The determination may be based on the indication of the AI model and the current state information (or the portions of the current state information for the network which are relevant for training the AI model). The determination may be further bases on the training requirements for the AI model if such were obtained. The knowledge network topology may indicate selected nodes, node clusters, node sub-clusters, or a combination thereof, of the network which are useful in training the AI model, and interconnections therebetween. The interconnections may indicate significance of relationships between training data at the selected nodes, node clusters, node sub-clusters, or a combination thereof, the significance and the relationships being specific to training for the AI model as specified by the indication of the AI model.

Determining the knowledge network topology may include determining the group of nodes for training the AI model and determining any data relationships among the nodes of the group. In embodiments, the knowledge network topology may be represented in any way suitable for representing data relationships among nodes of the group for training the AI model. For example, the knowledge network topology may be represented as a node relationship graph with respect to the training data accessible to nodes of the group, using a directed graphs, using a tabular format, using Markov chains, etc. The vertices of such graph may represent nodes of the group with relevant data for training a particular AI model. Edges of the graph may represent the significance of the training data at each node in relation to other nodes of the group for training particular AI model at those nodes.

In an embodiment, determining the knowledge network topology may include computing a metric for each <dataset, neural network> pair and then use the computed metrics to sort nodes based on such metrics.

Determining the knowledge network topology may include processing (e.g., analyzing, normalizing, correlating, etc.) the current state information obtained from the (e.g., networkwide) database based on the AI model indication and training requirements for the AI model. The determining of a knowledge network topology for one AI model may be independent of determining of a respective knowledge network topology for another AI model. In some examples, two AI models may require similar training data (e.g., one model requires images of dogs, while another model requires images of small dogs for training) and the respective knowledge network topologies and groups of nodes thereof may include same nodes and same or similar training data thereof. In other examples, two AI models may be substantially different and require respective training data having low to substantially zero similarity (e.g., one AI model may be a language processing model, while the other one may be an image processing model). In the latter example, the respective knowledge network topologies and groups of nodes thereof may have no node overlap or may have some common nodes each of which have access to respective training data for respective training of each AI model.

In embodiments, some or all of the current state information for the network may be or may include metrics or attributes that are static, i.e. predefined, substantially unchanged over a time period. Some or all of the current state information for the network may be or may include metrics or attributes that are dynamic, i.e. time-varying. In such case, variations in the dynamic current state information (or any dynamic metrics or attributes thereof) may be monitored (e.g., by the database, by the MTRCM) and the AI model training route may be adjusted, by the MTRCM or an instance thereof, in response to such variations in the current state information. The variations may be communicated as a new current state information (or an indication of a variation thereof) with the MTRCM via the control plane. In response, the MTRCM may adjust the training route by updating the knowledge network topology, the group of nodes, any data relationships of nodes of the group, and select at least one next node for training the AI model. Therefore, the MTRCM is responsive to changes in the network. Furthermore, the MTRCM may adjust the length of the training route so that the length is a decreasing function of the rate of occurrence of changes in the network. This conserves computing resources and facilitates appropriate recomputing of the route.

In embodiments, the (e.g., networkwide) database includes raw or substantially unprocessed data or information about the network and the nodes thereof representative of the current state of the network and the current state of the nodes. The current state of the network itself may include, for example, the topology of the network, the underlying network conditions, or both, reachability of the network, reachability of network regions (e.g., that may be affected by an outage, maintenance, update), visibility of the network, visibility of network regions, or a combination thereof. The current state of the network may include static, dynamic, or both static and dynamic metrics or attributes of the network. Static current state of the network may include network metrics or attributes that are predefined and remain substantially constant or stable over a predefined period of time. Non-limiting examples of static current state information of the network include network routing and forwarding protocols, routing tables, networking firewall and security settings, network topology, Domain Name System (DNS) settings, and other characteristics that generally define architecture and capabilities of the network. Non-limiting examples of dynamic metrics or attributes of the current state of the network include bandwidth utilization, latency, packet loss, traffic patterns, routing paths, network load, link status, wireless signal strength and quality, dynamic IP address allocation protocols, Quality of Service (QoS) metrics, network security events (intrusions, malware, etc.), and other network characteristics susceptible to change or variance in response to various factors such as user activity, network traffic, environmental conditions, etc.

The topology of the network, also known in the art as network topology and is distinct from the knowledge network topology described elsewhere herein, may be obtained via a network manager, administrator, provider, orchestrator, or a combination thereof, for example. The topology of the network may include generating the topology, for example, using network information obtained from the network manager, administrator, provider or orchestrator, directly from the network and nodes thereof, or a combination thereof. The topology of the network, as understood by a person skilled in the art, is descriptive of the physical and logical structure of the network and maps interconnections of network nodes. The topology of the network may include physical and logical locations of network nodes and other devices of the network, node types, connection types, link bandwidth, any network segments, regions, or subnetworks, routing paths, redundancies, backup links and routes, network hierarchy, virtual topology and network information, etc. The network topology may be static (e.g., over a period of time). The network topology may be dynamic and change in response to nodes joining or leaving the network. Nodes leaving or joining the network may be determined by the MTRCM, by the network topology, or both.

The underlying network conditions may include information about overall allocated or available bandwidth for network connections between nodes, network elements, computing devices, the networkwide database, actual (e.g., substantially currently) available bandwidth for network connections, latency (e.g., processing delay, transmission delay, propagation delay, etc.), network jitter, network congestion, quality of service metrics, network protocols, etc. The underlying network conditions may be static (e.g., over a period of time). The underlying network conditions may be dynamic and change, for example, in response to updates, network downtime related to maintenance, time of day, traffic congestion, etc.

In embodiments, the (i.e., information representative of the) current state of nodes may include, for some or all nodes of the network, one or more of: data availability, data age, data size, data type, data quality, data distribution, data variance, or other indications of the data held by the node. The current state of a node may include available resources of the node. The current state of a node may include node reachability from other one or more node of the network. The current state of a node may include node visibility to the MTRCM, to another one or more node of the network, or a combination thereof. The current state of a node may include other aspects such as privacy settings, permissions, or node trustworthiness with respect to securely training the AI model (e.g., AI model could be malicious to the UE or its training data, the UE or its training data could be malicious to the AI model training, a node may receive an AI model and make unauthorized modifications to it that may render the AI model malicious to another node, a node could make changes to the AI model that might prevent the MTRCM from being able to compute the best training route, etc.). Node visibility may include node status, such as active or idle. If UE has access to training data but the UE status is idle—such UE is visible (e.g., via the control plane to the MTRCM, the database) but not reachable as a result of its idle status. In such case, the MTRCM may be configured to wake up the UE before the UE can be used for AI mode training, for example by utilizing the control plane of the network and an underlying mobile network thereof.

In embodiments, the current state of a node is indicative of a current capability for training the AI model at the node. The current state of nodes (i.e., information representative thereof) may be obtained directly or indirectly (e.g., from an orchestrator, network manager, etc.) from the respective nodes of the network. If obtaining one or more current state metric or attribute of a particular node from the node is restricted, for example as a result of node privacy settings, such information, where possible, may be obtained via a network manager, provider, orchestrator, or a combination thereof, for example. The (e.g., networkwide) database includes information representative of the current state of each node and may include information of any node current state metric or attribute that is available or accessible via the control plane or control channel.

In embodiments, the (i.e., information representative of the) current state of nodes may include static, dynamic, or both static and dynamic current state metrics or attributes of nodes. Static current state metrics or attributes of nodes may be predefined and remain substantially constant or stable over a predefined period of time. Non-limiting examples of static current state metrics or attributes of a node include Media Access Control (MAC) address, hardware configuration, node type (e.g., computer, smart phone, etc.), any software, firmware or both, at the node related to AI model training (e.g., local MTRCM instance, local PEM instance), hostname, static Internet Protocol (IP) address, node role and function (e.g., provides training data, used for routing, provides MTRCM services, provides PEM services, etc.), access control settings, physical location, network policies and configuration, and other characteristics that generally define a node and its capabilities and typically require manual input from a user or a system administrator before being changed (e.g., updated, installed, removed). Non-limiting examples of dynamic current state metrics or attributes of a node include dynamic IP address, node reachability status, node reachability (e.g., from some or each of the other nodes of the network), resources available at a node for training the AI model, training data accessible to a node for training the AI model, amount of network traffic through a node, bandwidth utilization, resource utilization at a node, wireless signal strength and quality (e.g., may vary as a node moves, as environmental conditions change), link status, active sessions, security events (e.g., intrusions, malware, policy violations), node power consumption and status, dynamic DNS attributes, and other node characteristics susceptible to change or variance in response to various factors such as user activity, node operation, network conditions, etc.

In embodiments, the current state information may be maintained and kept up to date in a database which is local to or remote from a network node or a computing device at which the MTRCM is located. The database may be referred to as a networkwide database. The database may be generated (e.g., created, obtained, populated) and maintained (e.g., updated, organized). The control plane may operate to maintain the database. The database may be generated, for example, before or during a deployment or implementation phase of embodiments of systems and methods for AI model training disclosed herein. The database may be an existing global database in the network that includes current state information representative of the current state of the network and the current state of the nodes, or the networkwide database may be generated, maintained, or both generated and maintained, fully or in part, using current state information obtained from such an existing global database, for example.

In embodiments, the database includes information available to it via the control plane, including the current state information for the network that includes the information representative or indicative of the current state of the network and the information representative or indicative of the current state of nodes of the network.

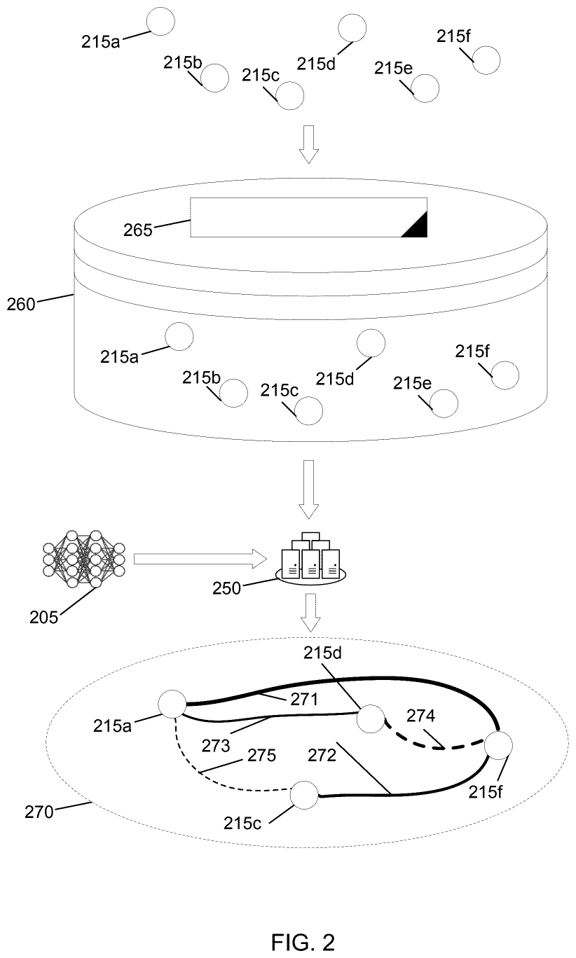

FIG. 2 schematically illustrates a knowledge network topology 270 including a group of (candidate) nodes (i.e., 215a, 215c, 215d, and 215f) determined by an MTRCM 250 for training the AI model 205, according to an embodiment. The network includes a plurality of nodes, such as, for example, a first node 215a, a second node 215b, a third node 215c, a fourth node 215d, a fifth node 215e, and a sixth node 215f, each having respective current state. Respective current states of the nodes (i.e., data, information representative thereof, or both) are stored in a database 260, which may be a networkwide database. The database 260 stores and may update, organize, or both update and organize, current state information representative of the current state of nodes and current state of the network 265.

The MTRCM 250 determines the knowledge network topology 270 based on the current state information of the database 260, the indication (not shown) of the AI model and, if obtained, training requirements for the AI model 205, for training the AI model 205 in accordance with the AI model training constraints. The knowledge network topology 270 includes nodes that at least have access to training data for training the AI model 205 and resources for training the AI model 205. By way of example, the knowledge network topology, as determined by the MTRCM 250 in accordance with the training constraints of the AI model and current state information, includes the first node 215a, the third node 215c, the fourth node 215d, and the sixth node 215f.

The knowledge network topology includes information indicative of relationships between respective training data for training the AI model 205 accessible to each node of the group of nodes 270, illustratively represented in FIG. 2 as lines of respective type and weight between node pairs of the knowledge network topology 270.

Data relationship 271 between the first node 256a and the sixth node 215f may be indicative of a significant (e.g., 75%) correlation between all respective node training data, for example. Data relationship 272 between the third node 215c and the sixth node 215f may be indicative of a somewhat significant (e.g., 30%) data type overlap between all respective node training data, for example. Data relationship 273 between the first node 215a and the fourth node 215d may be indicative of a minor (e.g., 12%) data age correlation between all respective node training data, for example. Data relationship 274 between the fourth node 215d and the sixth node 215f may be indicative of significant (e.g., 82%) data hierarchy correlation between a portion (e.g., 50%) of respective node training data, for example. Data relationship 275 between the first node 215a and the third node 215c may be indicative of a minor (e.g., 22%) data size similarity between a portion (e.g., 35%) of respective node training data, for example.

In embodiments, the MTRCM is in communication with the database and uses the current state information for the network stored thereat to determine a knowledge network topology including a group of nodes for training the AI model. The database may communicate with the MTRCM via the control plane, for example for notifying the MTRCM of a change (e.g., update, malfunction, unavailability, etc.) in the operation (e.g., high traffic, system error, update or maintenance in progress, database update notification), accessibility (e.g., access rules, database organizational and access structure and protocols), content (i.e., current state information) of the database, or a combination thereof. Additionally or alternatively, the MTRCM may request, via the control plane, a status update of the database therefrom, for example periodically, before determining a knowledge network topology or a group of nodes thereof, before selecting a node from the group of nodes for training the AI model, and combinations thereof.

In embodiments, the database may be stored in the network, for example, at a dedicated at least one network element having access to a dedicated at least memory, a dedicated at least one processor, a dedicated at least one server, or a combination thereof. The database may be updated to advantageously maintain the information representative or indicative of the current state of the network and the current state of nodes, e.g., as current as possible. The database may be updated at preset update intervals which may be fixed or may be adjustable, for example manually (e.g. via user or administrator input), or in response to an increase in frequency of changes in one or more current state metric or attribute of the network, one or more respective current state metric or attribute of one or mode node, or both. The database may be updated, for example by default, in response to a change in a one or more current state metric or attribute of the network, in response to a change in a one or more current state metric or attribute of a one or more node of the plurality of nodes, or both. The database may be updated in response to a network event, such as a power outage, network update, network merging, etc.

In embodiments, the current state information stored in the database may be used to generate and maintain (e.g., keep updated, structured, organized, processed) a networkwide knowledge network topology. Generating the networkwide knowledge network topology may include similar steps and systems to determining (i.e., model-specific) knowledge network topology described elsewhere herein, including determining a group of (i.e., candidate) nodes for training an AI model, while being generated in accordance with a set of AI models. The set may include multiple predefined AI model types, for example. As a result, the generated networkwide knowledge network topology may be representative of any (e.g., all or some) nodes of the network that at least have access to respective training data for training of the AI models of the set. The networkwide knowledge network topology includes a set of nodes for training the set of AI models and may include any respective training data relationships between nodes of the set. Unlike the database, the networkwide knowledge network topology includes processed current state information in accordance with the set of AI models.

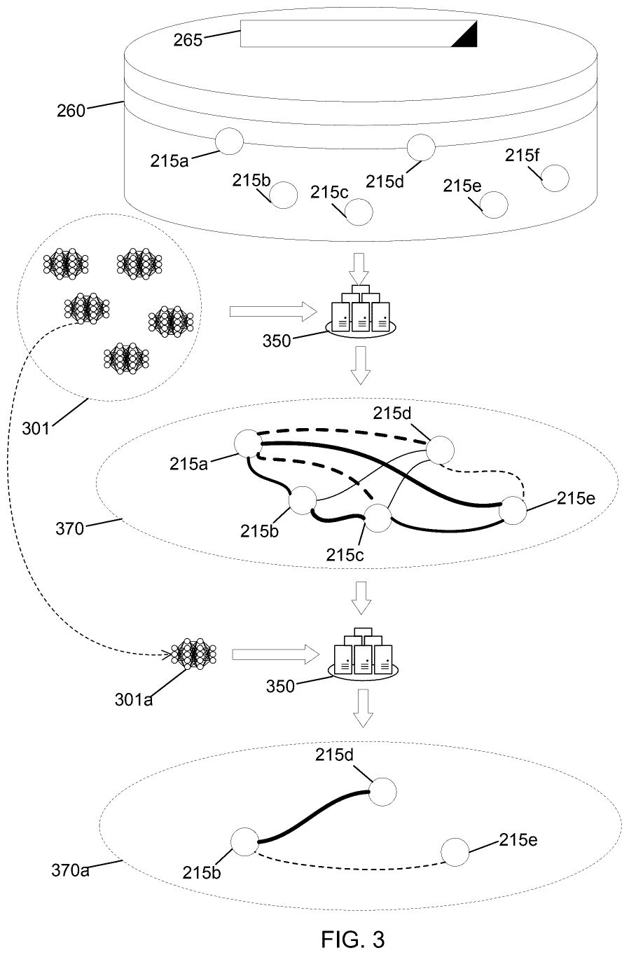

FIG. 3 schematically illustrates a group of (i.e., candidate) nodes 370a determined by an MTRCM 350 for training an AI model 301a of a set AI models 301, according to an embodiment. The network includes a plurality of nodes, such as, a first node 215a, a second node 215b, a third node 215c, a fourth node 215d, a fifth node 215e, and a sixth node 215f, with reference to FIG. 2. Respective current state of nodes (i.e., data, information representative thereof, or both) are stored in the database 260. The database 260 stores and may update, organize, or both update and organize, current state information representative of the current state of nodes and network current state 265.

The MTRCM 350 determines a networkwide knowledge network topology 370 for training a predefined set of AI models 301. The networkwide knowledge network topology 370 includes candidate nodes 215a, 215b, 215c, 215d, and 215e for training each AI model of the set 301. Each node of the networkwide knowledge network topology 370 has access to training data for training of at least one AI model (e.g., type) of the set of AI models (e.g., types) 301. The networkwide knowledge network topology 370 may include information representative of respective training data relationships among the nodes of the set 301.

The MTRCM 350 determines a (i.e. model-specific) knowledge network topology 370a including candidate group of nodes (i.e., nodes 512b, 215d, and 215e) for training a particular AI model 301a of the AI model set 301 using the networkwide knowledge network topology 370, the indication of the AI model 301a and, if obtained, training requirements of the AI model 301a. The knowledge network topology 370a includes nodes 215b, 215d, and 215e that at least have access to training data for training the AI model 370a and resources for training the AI model 370a. The knowledge network topology 370a therefore includes a subset of nodes (i.e., nodes 215b, 215d, and 215e) from the nodes of the networkwide knowledge network topology. The group of nodes 370a includes information indicative of relationships between respective training data for training the AI model 301a accessible to each node of the group of nodes 370a.

In embodiments, the group of nodes for training the particular AI model determined using the networkwide knowledge network topology includes one or more nodes thereof. Data relationships of the nodes of networkwide knowledge network topology may be used to facilitate determining of data relationships among the nodes of the group of nodes for the particular AI model. The networkwide knowledge network topology may be utilized in determining the group of nodes and any corresponding data relationships as long as the networkwide knowledge network topology is generated for a set of AI models (e.g., types) that includes the particular AI model (e.g., type). In cases where a specific AI model is different (e.g., different type) from the set of AI models used for generating the networkwide knowledge network topology, the respective group of nodes for training the specific AI model may be determined using the (e.g., networkwide) database.

Generating the networkwide knowledge network topology may be advantageous in high-service scenarios where requests for AI model training are received at above a predetermined volume or frequency. In such scenarios, determining a respective group of nodes for training of any AI model (e.g., type) of the set (e.g., of AI model types) may be more efficient and less resource consuming using the pre-processed data of the networkwide knowledge network topology for such determining instead of the raw (e.g., unprocessed, unanalyzed) data of the networkwide database. The computational and storage costs associated with generating and updating the networkwide knowledge network topology may be evaluated against the benefits of using the pre-processed data thereof for determining a group of nodes for the training the AI model instead of the raw data of the database.

In embodiments, a number of zonal networkwide knowledge network topologies may be implemented, each associated with a respective zone or region in the network. Collectively, such zonal topologies may form the networkwide knowledge network topology.

In embodiments, the model-specific knowledge network topology may be generated for a particular AI model without requiring a networkwide knowledge network topology. Instead, the model-specific knowledge network topology is generated based on information regarding the AI model in particular, along with information regarding the current state of the network and nodes thereof (including their data).

In embodiments, the MTRCM may be in communication with the networkwide knowledge network topology and use it together with at least one training constraint of the AI model, to determine a group of nodes for training the AI model, provided the AI model is of a set (e.g., type) of AI models used in generating the networkwide knowledge network topology. The networkwide knowledge network topology may be communicatively coupled to the MTRCM via the control plane, for example for notifying the MTRCM of a change in the operational state of the networkwide knowledge network topology (e.g., update, malfunction, unavailability, etc.). Additionally or alternatively, the MTRCM may request status updates of the networkwide knowledge network topology therefrom, for example periodically, before determining a group of nodes, before selecting a node from the group of nodes for training the AI model, and combinations thereof.

In embodiments, the networkwide knowledge network topology may be stored in communication with the network and is accessible via the control plane and the data plane. The networkwide knowledge network topology may be stored, for example, at a dedicated at least one network element, a dedicated at least one memory, a dedicated at least one server, or a combination thereof. The networkwide current state topology may be updated to advantageously maintain the information thereof as current as possible. The networkwide knowledge network topology may be updated at respective preset update intervals which may be fixed or may be adjustable, for example manually (e.g. via user input). The networkwide knowledge network topology may be updated, for example by default, in response to at least one update of the database. The networkwide knowledge network topology may be updated in response to a network event, such as a power outage, network update, network merging, etc.

In embodiments, the MTRCM and any instance thereof is configured to receive an indication of AI model for training at nodes of the network. The indication of the AI model may include one or more of: an AI model structure, an AI model architecture, an indication of one or more activation functions of the AI model, and training requirements for the AI model. The indication of the AI model may include all information necessary for defining the AI model. The indication may be received from a model owner, a user device, a service provider, a system orchestrator, for example. The indication may include the AI model for training at nodes of the network. The indication may include instructions for obtaining the AI model for training. The indication may include other instructions for returning the AI model after training, for example.

In embodiments, the MTRCM and any instance thereof is configured to obtain training requirements, described elsewhere herein, for training the AI model. Obtaining some or all of the training requirements may include receiving thereof from the entity providing the AI model, the indication thereof, or both, for training. Obtaining some or all of the training requirements may include determining thereof based on the received AI model, the received indication thereof, or both.

In embodiments, the MTRCM is configured to select a node (e.g., a node cluster, a node sub-cluster, or a combination thereof) from the determined group of nodes (e.g., node clusters, node sub-clusters, or a combination thereof, respectively) for training the AI model.

In embodiments, the AI model may be trained at a same node, node cluster, or node sub-cluster more than once using same or similar (e.g., a subset) training data.

In embodiments, the MTRCM may be configured to obtain (e.g., receive) performance evaluation information (e.g., a performance indicator, a performance value, a KPI value, a performance metric value) indicative of current performance of the AI model trained at a selected node from a PEM, or from a node correspondingly configured (e.g., instructed by the MTRCM) to obtain and provide such the performance evaluation information to the MTRCM. The MTRCM may use the received performance evaluation information to determine or update the route for training the AI model based at least in part on such information. In accordance with obtained performance evaluation information of the AI model trained at the selected node, the MTRCM (e.g., directly or via correspondingly instructing the selected node) or the selected node may determine that the current performance of AI model trained at the selected node fails to meet at least one training requirement, if such was obtained. If the current performance of the AI model trained at the selected node fails to meet at least one training requirement or, in absence of any training requirements, is estimated to be unsatisfactory for adequate functioning (e.g., inference) of a trained AI model, the MTRCM may select another node (e.g., from a previously determined group or from an updated group of (i.e., candidate) nodes determined for training the AI model) of a route to which to provide the AI model for further training. The data channel may be used to provide the AI model trained at the selected node to another (i.e., next, subsequent) node to further train the AI model.

In embodiments, the MTRCM may be configured to optimize training of multiple AI model being trained, at least in part, concurrently. Optimizing training may include optimizing (e.g., balancing) a load (e.g., resource, computation, communication) of the nodes, the MTRCM, the control plane, or a combination thereof, such that the AI models being trained are able to achieve an acceptable training performance. For example, if a large number of AI models are provided for training, and are to be trained, at least in part, simultaneously, and given that the system (e.g., system 800 with reference to FIG. 8) has limited resources and training data to train all provided AI models, the MTRCM may be configured to coordinate training of such AI models such that all of them can be trained to respective acceptable performance given the limited resources available.

For each selected node, the MTRCM may be configured to determine and specify hyperparameters for use in training the AI model at one or more selected node using training data accessible to the selected node. The hyperparameters may include one or more of learning rate, batch size, number of epochs, optimization settings, loss function, model architecture, regularization, initialization, training rate, learning rate schedule, validation split, etc., as readily understood by a person skilled in the art. Hyperparameters, any instructions including or indicative of hyperparameters, or a combination thereof, may be provided by the MTRCM to a node via the control plane. Hyperparameters may be included in overall training instructions which may also include instructions to reach the selected node for training, instructions to one or more selected node to initiate an evaluation of current performance of the AI model, and instructions to one or more selected node to adjust further training of the AI model based on results of the evaluation, for example.

In some embodiments, the hyperparameters, any instructions including or indicative of hyperparameters, or a combination thereof, may be provided (e.g. forwarded, transmitted, sent), via the control plane, to a node by another node having such hyperparameters, instructions, or both hyperparameters and instructions, available thereto, for example from a previous node or the MTRCM or an instance thereof.

In embodiments, the MTRCM and any instance thereof is configured to determine a route traversing a sequence of node clusters, nodes, or a combination thereof, for training an AI model. Each node in the sequence is to be used in turn (i.e., sequentially) for sequential training of the AI model using respective resources and data available to the node, as the AI model is forwarded along the route. The MTRCM determines the sequence of node clusters and nodes from nodes of the knowledge network topology and the determined group of nodes thereof. The MTRCM may cause forwarding, e.g. via the data plane, of the AI model to a next node in the sequence according to the route. The MTRCM may forward the AI model directly or may correspondingly configure (e.g., instruct) a node to forward the AI model to the next node in the sequence according to the determined route.

In embodiments, the sequence can identify the order of node clusters the model is to be trained at. Once the model is at one node cluster (e.g., at one of the associated nodes thereof or at a regional MTRCM instance associated therewith), a (e.g., local or regional) MTRCM instance associated with the node cluster may determine a sub-route traversing a (e.g., sub) sequence of nodes or sub-nodes as the case may be, within the node cluster for training the AI model. The MTRCM associated with the node cluster may be configured to determine a training method for training the AI model within the node cluster. For example, at one node cluster of the sequence, the AI model may be trained via traditional Federated Learning, and at another node cluster of the sequence, the AI model can be further trained sequentially within the node cluster.

In embodiments, the sequence may include one node or multiple nodes (e.g., of the knowledge network topology or the determined group of nodes thereof). A number of nodes in the sequence (i.e. the length of the sequence) can be configured based at least in part on a rate of change of the current state information. Following training at a last node in the sequence of nodes, the MTRCM or another instance thereof may determine a further sequence of nodes to be used in further training of the AI model. Therefore, the MTRCM(s) can steer the AI model for training via a sequence of steering operations.

The rate of change may be (e.g., substantially continuously or periodically) monitored and may be evaluated against a predefined rate of change threshold, for example by the MTRCM, by the database, by the control plane, or a combination thereof. Reaching a predefined upper rate of change threshold may, at least in part, result in the sequence including a single (e.g., selected) node, in which case, if further training is needed after training at the single node, another sequence or an updated sequence can be determined for further training the AI model. The upper rate of change threshold can be predefined such that any rate of change at or above such threshold results in a significant impact on the AI model training, that can, at least in part, be mitigated by updating the sequence of nodes (e.g., updating the knowledge network topology, the group of nodes thereof, updating data relationships thereof) such that a next node selected for training is selected taking into account the most up-to-date current state information for the network.

Reaching a predefined lower rate of change threshold may, at least in part, result in the sequence including multiple (e.g., selected) nodes forming a route, in which case, the AI model will be trained sequentially at each of the multiple nodes. The lower rate of change threshold can be predefined such that any rate of change at or below such threshold results in a minimal or substantially insignificant impact on the AI model training. The sequence (e.g., an indication thereof and corresponding instructions) including multiple nodes may be forwarded, by the MTRCM or a node configured accordingly by the MTRCM, to a next node of the sequence along with the AI model and used to direct further forwarding of the AI model through the multiple nodes of the sequence in turn for training thereat. That is, the steering information can accompany the AI model for use by nodes in forwarding the AI model along the route according to the steering information.

In embodiments, the sequence of nodes includes at least one node from the knowledge network topology and the determined group of nodes thereof. The sequence is representative of a training route or path for training the AI model sequentially at nodes of the sequence. The first node of the sequence is selected as the first or initial selected node for training the AI model. The sequence of nodes may include any number of nodes from the group of nodes such that the performance of the AI model having been trained at each node of the sequence is estimated, by the MTRCM, to meet training requirements. The sequence of nodes may include a same node more than once. For example, the AI model may be passed back and forth between two (or more) nodes repeatedly as part of the training, as the data at these nodes is correlated. Each instance of the same node in the sequence may include hyperparameters respective to the instance and use same or somewhat same (e.g., a second instance uses a portion of training data used for the first instance) training data.

The MTRCM may provide sequence instructions to a selected node instructing the selected node to provide the AI model trained thereat to a next node in the sequence for further training the AI model, provided the current performance of the AI model after being trained at the selected node does not meet training requirements.

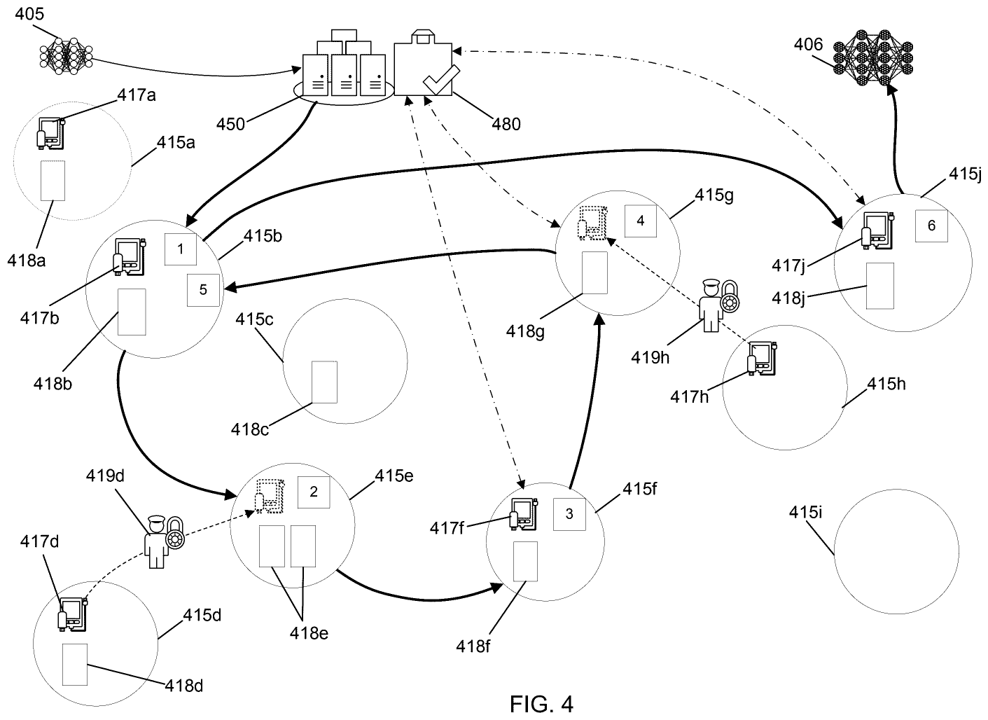

FIG. 4 schematically illustrates training an AI model 405, according to an embodiment. A network includes ten nodes 415a through 415j. Node 415a, although having respective training data 417a and resources 418a, is unreachable and therefore is not selected for training the AI model 405. Node 415c doe has resources 418c but no access to respective training data for training the AI model 405 and therefore is not selected for training the AI model. Node 415i has no respective training data or resources for training the AI model 405 and therefore is not selected for training the AI model.

The first (i.e., initial node) selected node from the sequence by the MTRCM 450 is node 415b having respective training data 417b and resources 418b for training the AI model 405. After training at node 415b, the AI model is sent (e.g., automatically as instructed in training instructions provided by the MTRCM 450 with the AI model 405), by node 415b, to a second selected node 415e of the sequence. The second selected node 415e has access to respective training data 417d of node 415d and resources 418e for training the AI model 405 received from the first selected node 415b. After training at the second selected node 415e, the AI model 405 is sent (e.g., automatically as instructed in training instructions provided by the MTRCM 450 with the AI model 405), by node 415e, to a third selected node 415f having respective training data 417f and resources 418f for training the AI model 405.

After training at node 415f, the performance of the AI model 405 is evaluated (e.g., automatically as instructed in training instructions provided by the MTRCM 450 with the AI model 405) by a PEM 480 in communication with the MTRCM 450. The PEM 480 determines that AI model performance does not meet a predetermined performance metric value and the AI model is sent (e.g., automatically as instructed in training instructions provided by the MTRCM 450 with the AI model 405), by node 415f, to a fourth selected node 415g of the sequence. The fourth selected node 415g has access to respective training data 417h of node 415h and resources 418g for training the AI model 405 received from the third selected node 415f.

After training at node 415g, the performance of the AI model 405 is evaluated (e.g., automatically as instructed in training instructions provided by the MTRCM 450 with the AI model 405) by the PEM 480. The PEM 480 determines that AI model performance does not meet a predetermined performance metric value and the AI model is sent (e.g., automatically as instructed in training instructions provided by the MTRCM 450 with the AI model 405), by node 415g, to a fifth selected node 415b of the sequence. The fifth selected node is notably the same node as the first selected node in this example. However, the respective training data used for training the AI model at node 415b for the second time (i.e., in the fifth selected training step) may be the same, similar, or a subset of training data 417b used for training the AI model at the first step when the AI model 405 was trained at node 417f for the first time.

After training at node 415j, the performance of the AI model 405 is evaluated (e.g., automatically as instructed in training instructions provided by the MTRCM 450 with the AI model 405) by the PEM 480. The PEM 480 determines that AI model performance meets the predetermined performance metric value. Notably, as described elsewhere herein, the PEM may determine current performance of the AI model using a data sample and provide the current performance information, for example, to an MTRCM instance or a node correspondingly configured, for evaluation. At this time the AI model training is complete and the trained AI model 406 may be provided, for example, to a user device that requested training of the AI model 405.

In some embodiments, the sequence may be a partial sequence. For example, an AI model may be trained at a first node and at one subsequent node, at which a local instance of the MTRCM may determine a sequence of subsequent three nodes for further training of the AI model. Determining a partial sequence may be advantageous, for example, for networks where the stability of training data, resources, or both data and resources, is dependent on a time of day and the rate of change of current state information varies accordingly. During a high network usage corresponding to frequent changes in respective training data of nodes, nodes may be selected one at a time, and during a low network usage corresponding to a predefined level of stability in respective training data of nodes, a partial sequence may be selected for sequential training of nodes.

In some embodiments, the MTRCM may send the AI model to the first selected node of the sequence with training instructions for subsequent training at each node of the sequence. The training instructions may include hyperparameters for each node and any separate instances of same node(s) of the sequence, and instructions to reach each subsequent node. The MTRCM may determine a performance evaluation schedule for training the AI model at the sequence of nodes. Some or all nodes of the sequence may be selected for respective performance evaluation to be performed by a PEM (or a particular instance thereof). For example, more frequent performance checks may be scheduled by the MTRCM in association with nodes further in the sequence where the training performance is estimated to be approaching a target performance metric value or criterion (e.g., KPI).

In some embodiments, the MTRCM may provide training sequence instructions one node at a time. For example, the MTRCM may provide training instructions for training at a next node of the sequence only after training the AI model at a preceding node of the sequence, thereby increasing privacy of other nodes of the sequence and the overall training privacy of the AI model, for example. Providing, by the MTRCM, training instructions for the whole or only a part of the training sequence of nodes may be in accordance with one or more predefined parameters, such as trustworthiness of a particular node being provided with training instructions, frequency of changes of respective training data of nodes, or a combination thereof, for example. A node receiving the AI model for training without any subsequent node training instructions may obtain such instructions from the MTRCM after training at the node is complete, for example.

In other words, if the MTRCM determines a sequence (whether full or partial) of nodes for training the AI model, the MTRCM may include training instructions for the whole sequence to the first selected node of the sequence along with the AI model. Alternatively, the MTRCM may keep the training instructions for the whole sequence thereat thereby requiring each node of the sequence to obtain next node instructions directly from the MTRCM regardless of whether knowledge network topology, the group of nodes thereof, the data relationships therebetween, or a combination thereof, is updated while the model is being trained at any one of the nodes of the sequence.

The MTRCM, the database, the control plane, or a combination thereof, may be configured to monitor rate of change of the current state information to determine a variation in static, dynamic, or both static and dynamic current state metrics or attributes of (e.g., all) nodes of the network from or with respect to previously obtained respective current state metrics and/or attributes of nodes.

In some embodiments, the MTRCM may be configured to update the (i.e., previously determined) knowledge network topology, the group of nodes thereof, the data relationships therebetween, or a combination thereof, to obtain updated knowledge network topology, updated group of nodes thereof, updated data relationships therebetween, respectively, or a combination thereof, for training the AI model. In other embodiments, the MTRCM may be configured to determine another (i.e., newly-determined) knowledge network topology including group of nodes thereof and data relationships therebetween for training the AI model. A newly-determined or updated knowledge network topology, group of nodes thereof, or both, may include some, all, or none of the nodes of the previously determined knowledge network topology, group of nodes, or both. Updating the knowledge network topology, group of nodes, or both, or determining a new knowledge network topology including the group of nodes includes updating, generating, or both updating and generating, any new data relationships between nodes thereof.

The new or updated knowledge network topology including a group of nodes may be determined, for example, in response to one or more update to the networkwide database, the networkwide knowledge network topology, or both, whichever one is used by the MTRCM for obtaining the new or updated group of nodes. The new or updated knowledge network topology including the group of nodes may be obtained by the MTRCM in response to determining (e.g., by receiving a corresponding indication, notification or update), by the MTRCM, the networkwide database of current state information, or both, one or more variation in static, dynamic, or both static and dynamic current state metrics or attributes of one or more node of the network.

In embodiments, the MTRCM may be configured to evaluate variations in (e.g., dynamic, static, or both) current state metrics or attributes against respective predefined threshold variations. A variation above a respective predefined threshold variation may necessitate obtaining a newly-determined or an updated knowledge network topology including the group of nodes in order to select a next node for training the AI model therefrom. Given the AI model requires further training (e.g., AI model performance is below a target performance criterion), determining that one or more variation in a current state metrics or attributes is below a respective predefined threshold variation, the MTRCM may determine a sequence of node clusters, node sub-clusters, or nodes, as the case may be, to which to provide, in sequence, the AI model for further training. In other words, an update in one or more current state metrics or attributes being below the predefined threshold variation is indicative of the one or more current state metrics or attributes being substantially (e.g., within a predefined variance) stable and unchanged. If overall current state metrics or attributes variance is low (e.g., within a predefined variance), the MTRCM may select the sequence of nodes instead of only a single next node for training the AI model.

The knowledge network topology including the group of nodes may be updated or a newly-determined at preset update intervals, such as specific times corresponding to high rate of training data change of nodes, or after a predefined amount of training time has been reached in training the AI model. The group of nodes may be updated or newly-determined in response to a system event, such as an MTRCM update, an update of one or more other systems of the network, a planned or unplanned outage of one or more components of the network (e.g., the MTRCM, the control plane, control channel, the data plane, data channel, etc.)

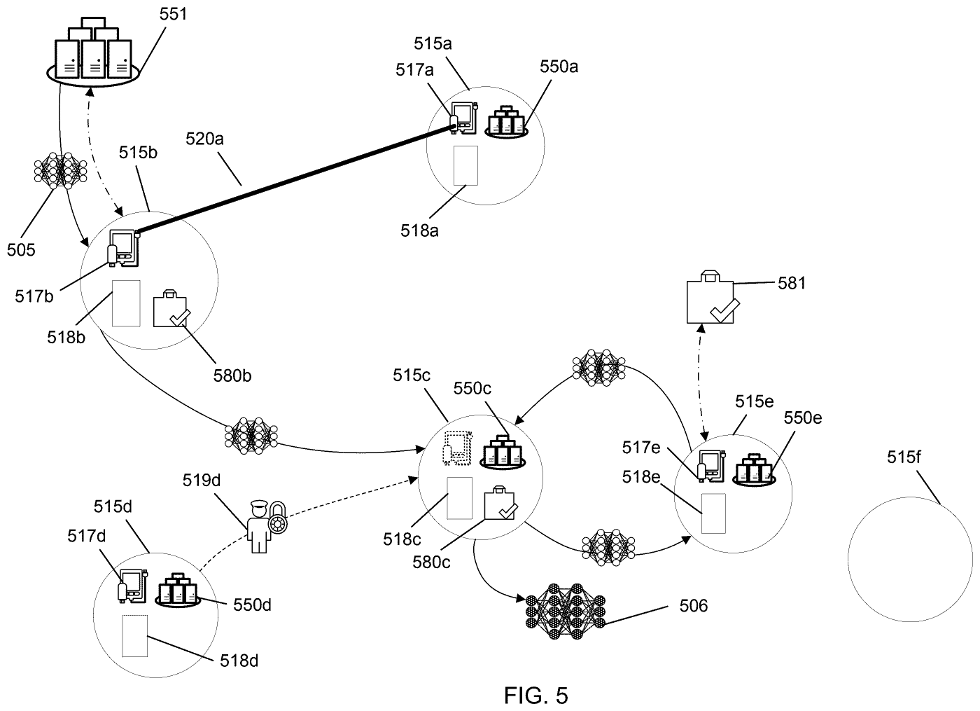

FIG. 5 schematically illustrates training an AI model 505, according to an embodiment. A network includes six nodes 515a through 515f. Node 515a, although having respective training data 517a, resources 518a and a local MTRCM instance 550a thereat, is not selected for training the AI model 505 because its respective training data 517a has a significant (e.g., 100%) data relationship 520a (e.g., is included in) with the respective training data 517b of node 515b. Node 515f has no respective training data or resources for training the AI model 405 and therefore is not selected for training thereof.

The first (i.e., initial node) node selected by a regional MTRCM instance 551 for training the AI model 505 is node 515b having respective training data 517b, resources 518b for training the AI model 505, and a local PEM 580b thereat. After training at node 515b, performance of the AI model is evaluated against a predetermined performance metric by the local PEM 580b at the node 515b. The local PEM 580b determines that AI model performance does not meet a predetermined performance metric value and node 515b obtains training instructions from the regional MTRCM 551. The obtained instructions include instructions to send the AI model 505 to a next (i.e., the second) selected node and indicate corresponding hyperparameters for training the AI model thereat. In accordance with received instructions, node 515b sends the AI model 505 to the second selected node 515c having authorization 519d to access respective training data 517d of node 515d and resources 518c for training the AI model 505.

After training at node 515c, the performance of the AI model 505 is evaluated by a local PEM 580c at the node 515c. The local PEM 580c determines that that AI model performance does not meet the predetermined performance metric value. The local MTRCM instance 550c at the node 515c selects a next (i.e., third) node for training the AI model. The node 515c sends the AI model along with corresponding hyperparameters determined by the local MTRCM instance 580c to the third selected node 515e having respective training data 517e and resources 518e for training the AI model 505.

After training at node 515e, node 515e communicates with a regional PEM 581 for evaluation the performance of the AI model. The regional PEM 581 determines that AI model performance does not meet the predetermined performance metric value. The local MTRCM instance 550e at the node 515e selects a next (i.e., fourth) node for training the AI model. The node 515e sends the AI model along with corresponding hyperparameters determined by the local MTRCM instance 580e to the fourth selected node 515c having. Notably, the fourth selected node is the same node as the second selected node, and therefore the AI model 505 is training at his node twice at different training iterations or steps.

After training at node 515c (i.e., for the second time, at the fourth step), the performance of the AI model 505 is evaluated by the local PEM 580c at the node 515c. The local PEM 580c determines that that AI model performance meets the predetermined performance metric value. At this time the AI model training is complete and the trained AI model 506 may be provided, for example by the local MTRCM instance 550c, to a user device that requested training of the AI model 505.

In embodiments, training data used for training the AI model at a same node more than once may be identical for each training step at the node, or may be somewhat different (e.g. a subset of all training data accessible to the node). The MTRCM may determine respective hyperparameters for each training instance of the AI model at the same node. Training the AI model at a same node using identical or similar training data accessible thereto and using corresponding hyperparameters may improve training consistency, may be used for model training validation, may improve model diversity, or a combination thereof.

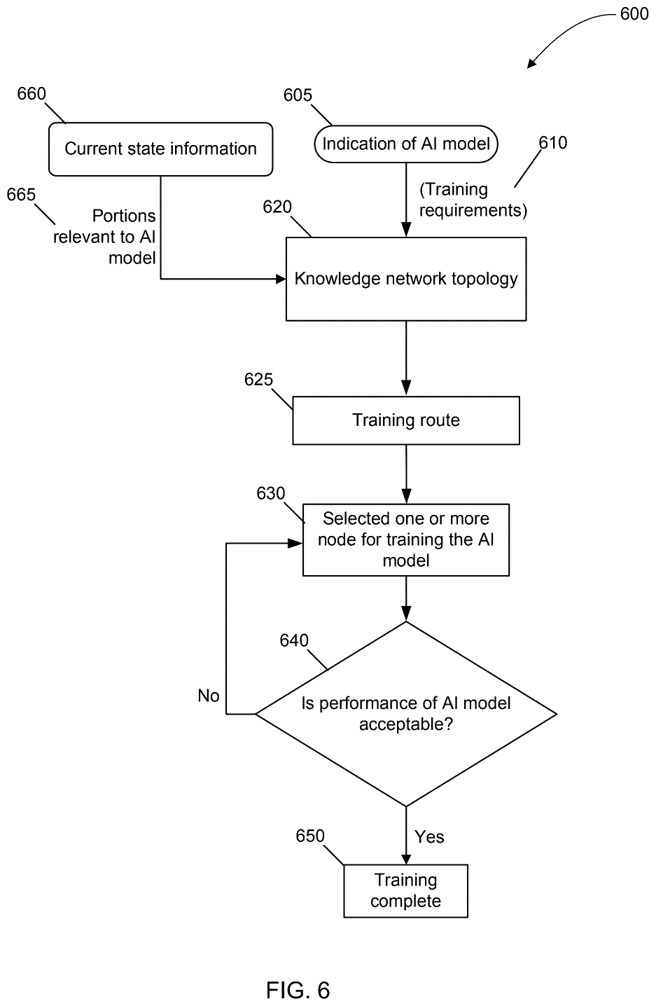

FIG. 6 shows a flowchart for a method 600 for training an AI model. The method includes receiving an AI model indication 605. The method may include obtaining training requirements 610 for the AI model. The method includes determining a knowledge network topology 620 based on the AI model indication 605, portions 665 of the current state information 660 relevant to the AI model, and, if such were obtained, the training requirements 610 for the AI model. The method includes determining a training route 625 traversing a sequence of node clusters, node sub-cluster, nodes, or a combination thereof, for training the AI model. In accordance with the training route 625, one or more nodes 630 are selected for training the AI model sequentially at each of the selected one or more node 630. Rather than nodes, node clusters may be selected. The method 600 includes evaluating information indicative of the current performance 640 of the AI model having been trained at each of the selected one or more node 630. If the current performance of the AI model is acceptable (e.g., meets a predetermined training requirement, is within acceptable performance target such as KPI, no further training data available for training the AI model, etc.), then AI model training is considered complete 650. If the current performance of the AI model is not acceptable (e.g., does not meet a predetermined training requirement, is below acceptable performance target such as KPI, further training on new data may significantly improve AI model performance, etc.). In this case the method proceeds to selecting another one or more node 630 according to the training route 625 for further training the AI model. The method 600 can be implemented in network with slow rate of change of training data (or during time periods where such rate of change is, for example, predicted or expected to be slow), such that the knowledge network topology and the training route is typically determined only once.

Accordingly, once the training route is established, the model may be made to visit a next node along the training route, or possibly multiple next nodes. After such visitation, performance of the AI model is evaluated. If the performance is not yet acceptable, one or more further next nodes along the training route are visited and the process repeats.

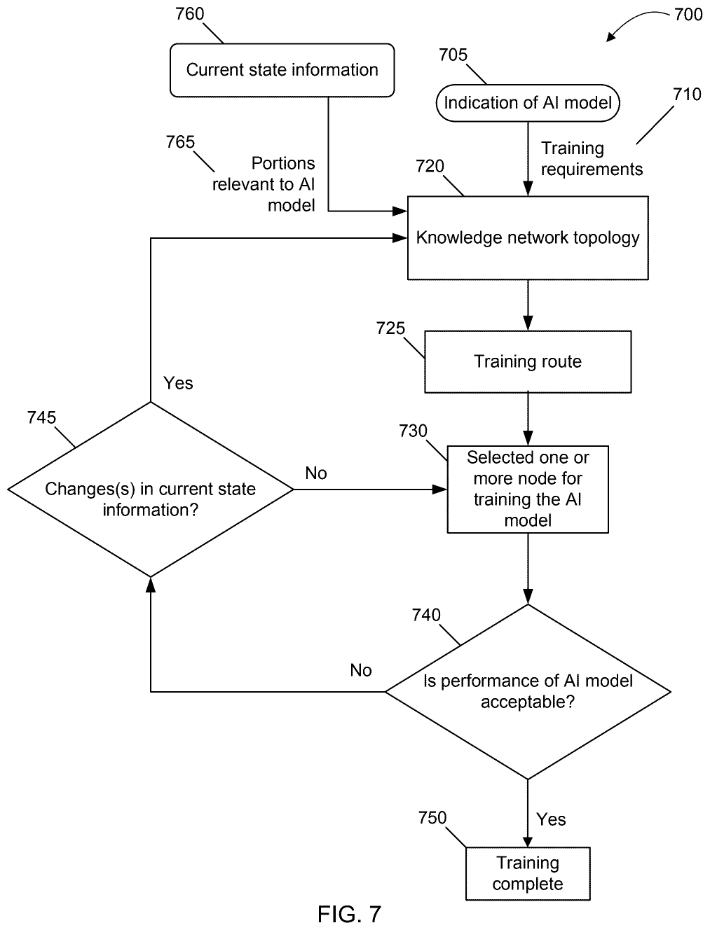

FIG. 7 shows a flowchart for a method 700 for training an AI model. The method includes receiving an AI model indication 705. The method may include obtaining training requirements 710 for the AI model. The method includes determining a knowledge network topology 720 based on the AI model indication 705, portions 765 of the current state information 760 relevant to the AI model, and, if such were obtained, the training requirements 710 for the AI model. The method includes determining a training route 725 traversing a sequence of node clusters, nodes, or a combination thereof for training the AI model. In accordance with the training route 725, one or more nodes 730 are selected for training the AI model sequentially at each of the selected one or more node 730. In some cases, a single node is selected 730. Rather than nodes, node clusters may be selected.

The method 700 includes evaluating information indicative of the current performance 740 of the AI model having been trained at each of the selected one or more node 730. If the current performance of the AI model is acceptable (e.g., meets a predetermined training requirement, is within acceptable performance target such as KPI, no further training data available for training the AI model, etc.), then AI model training is complete 750.

If the current performance 740 of the AI model is not acceptable (e.g., does not meet a predetermined training requirement, is below acceptable performance target such as KPI, further training on new data may significantly improve AI model performance, etc.), then the method proceeds to determining 745 if (e.g., significant) changes in the current state information 760 have occurred since last determining of the knowledge network topology 720 for the AI model.

If (e.g., significant) changes in the current state information 760 have not occurred, then the method proceeds to the described above steps of selecting (i.e., subsequent) one or more node 730 according to the route 725 for training the AI model and evaluating the information indicative of the current performance 740 of the AI model having been trained at each of the (i.e., subsequent) selected one or more node 730.

If substantial changes in the current state information 760 have occurred, then the method proceeds to above described steps of determining (or updating the previously determined) a knowledge network topology 720 based on the AI model indication 705, (i.e., up-to-date) portions 765 of the current state information 760 relevant to the AI model, and, if such were obtained, the training requirements 710 for the AI model; followed by selecting another one or more node 730 according to the training route 725 for further training the AI model.

The method 700 can be implemented in network with fast rate of change of training data (or during time periods where such rate of change is, for example, predicted or expected to be fast), such that the knowledge network topology and the training route can be updated and using the up-to-date (e.g., portions of the) current state information before further training the AI model. In such cases, and in some embodiments, a single node or node cluster can be selected 730 on each iteration.

FIGS. 6 and 7 illustrate determining a knowledge network topology. However, in some embodiments use of knowledge network topology is omitted. In such case, a training route can be determined based on current state information, and possibly based on training requirements.

FIG. 8 shows a schematic illustration of a system 800 for training AI models. The system 800 incudes a database 860 storing data representative or indicative of current state information for the network, including for node clusters of the network or nodes of the network, or both, whichever is applicable. The database 860 may include a manager 861 configured to maintain the database, process any received requests and instructions.

The system 800 incudes a control plane device (apparatus) 810 having a database handler 815 that includes a respective interface link 816 with nodes 801 of a respective network link 862 with the database 860. The database handler is configured to channel current state information from nodes 801 to the database 860 and includes corresponding protocols. The database handler can thus interact with the nodes to maintain up-to-date current state information. The control plane device 810 may include a training and performance evaluation instruction handler 825 configured to handle (e.g., channel, relay, transmit, provide) requests, responses, instructions, and information related to performance evaluation of AI models and includes corresponding protocols. The control plane device 810 may include an AI model mobility handler 835 configured to handle (e.g., channel, relay, transmit, provide) requests, responses, instructions, and information related to training status and performance evaluation of AI models and includes corresponding protocols.

The system 800 incudes an MTRCM device (apparatus) 850 configured to perform functions of the MTRCM or an instance thereof, as described elsewhere herein. The MTRCM device 850 includes a knowledge network topology builder 855 that includes a respective interface link 863 with the database 860. The knowledge network topology builder 855 is configured to determine (e.g., generate, build, update) a knowledge network topology for each particular AI model. In some embodiments, the knowledge network topology builder is configured to determine a networkwide knowledge network topology for a set of AI models. The knowledge network topology builder 855 may determine (or update) a group of candidate nodes for training a particular AI model, determine node status of nodes of the group, determine data relationships between nodes of the group, or a combination thereof. The knowledge network topology builder 855 may perform such functions with respect with nodes, node clusters, or both.

The MTRCM device 850 includes an AI model, training evaluation and training requirements processor 865 configured to process an indication of the AI model, evaluate training status and performance of the AI model, and obtain training requirements for the AI model. The processor 865 has a respective interface link with an entity 805, such as a client, providing the indication of the AI model and, where provided, training requirements for training the AI model. Such interface link may be used for receiving the AI model indication, receiving AI model training status requests and responding to such requests, providing AI model training status information to the client, or a combination thereof. The processor 865 has a respective internal communication link with the knowledge network topology builder 855.

The MTRCM device 850 includes a training route and sequence determiner and instruction generator 875 which is configured to determine a sequence of nodes of the group for sequentially training the AI model, determine a route traversing the sequence of nodes, select nodes for training the AI model, or a combination thereof. The instruction generator 875 is configured to generate corresponding instructions to be provided to the training and performance evaluation instruction handler 825 of the control plane device 810 via a respective interface link 876. The training and performance evaluation instruction handler 825 further includes a respective interface link 826 for handling corresponding instructions and route and sequence information between the nodes 801 and the control plane 810.

The MTRCM device 850 includes an AI model and training data mobility instruction generator 885 configured to generate instructions related to mobility and forwarding of the AI model and training data between nodes and, where implemented, MTRCM instances. Such instructions may be provided to the AI model mobility handler 835 of the control plane device 810 using a respective interface link 877. The AI model mobility handler 835 has a respective interface link 836 with nodes 801 for handing such and related instructions.

Notably, the AI model and training data mobility instruction generator 885 of the MTRCM device 850 and the AI model mobility handler 835 of the control plane device 810 are particularly applicable in centralized and regional implementations of the MTRCM where corresponding information and instructions (e.g., of a next selected node for providing the AI model to for training) can be provided, via the control plane, from MTRCM to a node that currently has the AI model being trained. Once such information and instructions are received by the node having the AI model, they may be unpacked and handled by a data plane to physically provide the AI model from the node to the indicated next selected node for further training the AI model.

In distributed implementation of the MTRCM locally at nodes, the AI model and training data mobility instruction generator 885 of the MTRCM device 850 and the AI model mobility handler 835 of the control plane device 810 may be omitted or (e.g., temporarily, until needed) disabled (e.g., turned off, uninstalled, removed) since the information and instructions for a selected next node for the route are typically generated at the node by its locally-implemented MTRCM instance (e.g., as long as it is usable). Therefore, the control plane does not necessarily need to be utilized for providing information and instructions to the node. In such scenarios, the information and instructions can be provided by the local MTRCM of the node having the AI model directly to the data plane for physically providing the AI model to the next selected node along with any instruction payload.

The MTRCM device 850 includes a number of internal links between its various components described above for relaying information, such as data and instructions for performing respective function thereof, therebetween. A respective internal link 866 is provided between the AI model, training evaluation and training requirements processor 865 and the AI model and training data mobility instruction generator 885. A respective internal link 867 is provided between the processor 865 and the training route and sequence determined and instruction generator 875. A respective internal link 858 is provided between the generator 875 and the knowledge network topology builder 855. A respective internal link 857 is provided between the topology builder 855 and the AI model and training data mobility instruction generator 885. A respective internal link 856 is provided between the topology builder 855 and the AI model, training evaluation and training requirements processor 865.

The system 800 may include other interface links and internal links between its components for relaying of corresponding information therebetween.

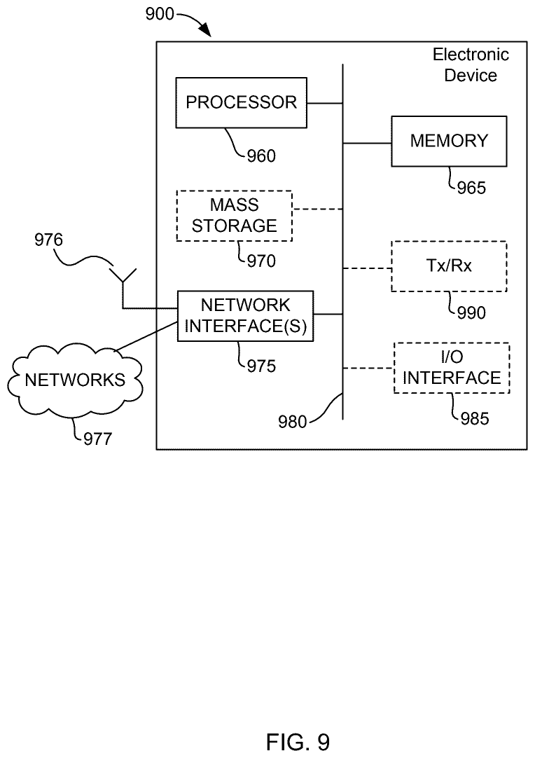

FIG. 9 shows a schematic diagram of an electronic device 900 that may perform any or all of the operations of the above methods and features explicitly or implicitly described herein, according to different embodiments of the present disclosure. For example, a computer equipped with network function may be configured as electronic device 900. The electronic device 900 may be used to implement the methods and systems described herein, for example and with reference to FIG. 8, the system 800, the control plane device 810, the MTRCM device 850, or a combination thereof. A number of devices 900 may be provided each including an instance of the MTRCM device 850, for example.

As shown, the electronic device 900 may include at least one processor 960, such as a Central Processing Unit (CPU) or specialized processors such as a Graphics Processing Unit (GPU), a Neural Processing Unit (NPU) or other such processor unit, memory 965, network interface 975, and a bi-directional bus 980 to communicatively couple the components of electronic device 900. The at least one processor 960 may be operatively coupled to a caching server. Electronic device 900 may also optionally include non-transitory mass storage 970, an I/O interface 985, and a transceiver 990. According to certain embodiments, any or all of the depicted elements may be utilized, or only a subset of the elements. Further, the electronic device 900 may contain multiple instances of certain elements, such as multiple processors, memories, or transceivers. Also, elements of the hardware device may be directly coupled to other elements without the bi-directional bus 980. Additionally or alternatively to a processor and memory, other electronics, such as integrated circuits, may be employed for performing the required logical operations.

The memory 965 may include any type of tangible, non-transitory memory such as static random access memory (SRAM), dynamic random access memory (DRAM), synchronous DRAM (SDRAM), read-only memory (ROM), any combination of such, or the like. The memory 965 in communication with the at least one processor 960 may have stored thereon a set of counters or slots for such set of counters or both. The mass storage element 970 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 965 or mass storage 970 may have recorded thereon statements and instructions executable by the at least one processor 960 for performing any of the aforementioned method operations described above.

Network interface 975 may include at least one of a wired network interface and a wireless network interface. The network interface 975 may include a wired network interface to connect to a communication network 977 and may also include a radio access network interface 976 for connecting to the communication network or other network elements over a radio link. The network interface 975 enables the electronic device 900 to communicate with remote entities such as those connected to the communication network 977.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology, to structure some or all of its components in accordance with the system of the technology, or a combination thereof.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present disclosure. For example, such an execution may correspond to a simulation of the logical operations as described herein. The software product may additionally or alternatively include number of instructions that enable a computer device to execute operations for configuring or programming a digital logic apparatus in accordance with embodiments of the present disclosure.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed is:

1. A system for supporting artificial intelligence (AI) model training using a network, the system comprising:
a control plane configured to:
repeatedly interact with nodes of the network to maintain up-to-date current state information for the network, including for each node cluster of a plurality of the node clusters in the network, the current state information indicative of: a current capability for training AI models using resources at the node cluster; and characteristics of AI model training data available to the node cluster; and
an AI model steering apparatus operatively coupled to the control plane and configured to:
receive an indication of an AI model for training at node clusters in the network;
obtain, from the control plane or an associated database, portions of the current state information for the network which are relevant for training the AI model;
based on the indication of the AI model and the portions of the current state information, determine a route traversing a sequence of the plurality of node clusters, each node cluster in the sequence to be used in turn for sequential training of the AI model using respective resources and data available thereto, as the AI model is forwarded along the route; and
cause forwarding of the AI model to a next node cluster in the sequence according to the route, the forwarding being via a data plane of the system.

2. The system of claim 1, further comprising one or more additional instances of the AI model steering apparatus, wherein the control plane is configured to distribute information to the AI model steering apparatus and the one or more additional instances of the AI model steering apparatus.

3. The system of claim 1, wherein for at least one node cluster, the current state information includes one or more of:
a type of data available at the node cluster for training the AI model;
a quality of data, of one or more types, available at the node cluster for training the AI model;
an amount of data, of one or more types, available at the node cluster for training the AI model;
an age of data, of one or more types, available at the node cluster for training the AI model;
a variation over time of one or more of: data, of one or more types, available at the node cluster for training the AI model; the type of data, the quality of data, the amount of data; and the age of data;
a reachability of the node cluster from other node clusters of the network;
a visibility of the node cluster to other node clusters of the network;
a trustworthiness of the node cluster with respect to securely training the AI model;
a sample of data held by one or more of the plurality of node clusters; and
information usable by the AI model steering apparatus for determining the route.

4. The system of claim 1, wherein the control plane is further configured to carry one or more of: instructions for training the AI model; and instructions for monitoring training of the AI model.

5. The system of claim 1, wherein each node cluster of the plurality of node clusters is a respective single node of the network or a respective plurality of nodes of the network.

6. The system of claim 1, wherein the AI model steering apparatus is further configured to: obtain training requirements for training the AI model; and
wherein the AI model steering apparatus is configured to determine the route traversing the sequence of the plurality of node clusters based further on the training requirements.

7. The system of claim 1, wherein the AI model steering apparatus is a first AI model steering apparatus, the plurality of node clusters includes a first node cluster having a plurality of node sub-clusters, the system further comprising:
a second AI model steering apparatus operatively coupled to the control plane and configured to:
receive the indication of the AI model for training;
obtain, from the control plane or the associated database, further portions of the current state information for the network which are relevant for training the AI model at the plurality of node sub-clusters;
based on the indication of the AI model and the further portions of the current state information, determine a sub-route traversing a sequence of the plurality of node sub-clusters, each node sub-cluster in the sequence of the plurality of node sub-clusters to be used in turn for sequential training of the AI model using respective resources and data available thereto, as the AI model is forwarded along the sub-route; and
cause forwarding of the AI model to a next node sub-cluster in the sequence of the plurality of node sub-clusters according to the sub-route, the forwarding being via the data plane of the system.

8. An apparatus in a network, the apparatus configured to:
receive an indication of an artificial intelligence (AI) model for training at node clusters in the network;
obtain current state information for the network, including for each node cluster of a plurality of the node clusters in the network, the current state information indicative of: a current capability for training the AI model using resources at the node cluster; and characteristics of AI model training data available using the node cluster;
based on the indication of the AI model and the current state information, determine a route traversing a sequence of the plurality of node clusters, each node cluster in the sequence to be used in turn for sequential training of the AI model using respective resources and data available thereto, as the AI model is forwarded along the route; and
cause forwarding of the AI model to a next node cluster in the sequence according to the route.

9. The apparatus of claim 8, wherein each node cluster of the plurality of node clusters is a respective single node of the network or a respective plurality of nodes of the network.

10. The apparatus of claim 8, wherein the apparatus is further configured to:
obtain training requirements for training the AI model; and
wherein the apparatus is configured to determine the route traversing the sequence of the plurality of node clusters based further on the training requirements.

11. The apparatus of claim 8, wherein for at least one node cluster, the current state information is provided using a control plane and includes one or more of:
a type of data available at the node cluster for training the AI model;
a quality of data, of one or more types, available at the node cluster for training the AI model;
an amount of data, of one or more types, available at the node cluster for training the AI model;
an age of data, of one or more types, available at the node cluster for training the AI model; and
a variation over time of one or more of: data, of one or more types, available at the node cluster for training the AI model; the type of data, the quality of data, the amount of data; and the age of data.

12. The apparatus of claim 8, wherein for at least one node cluster, the current state information is provided using a control plane and includes one or more of:
a reachability of the node cluster from other node clusters of the network;
a visibility of the node cluster to other node clusters of the network; and
a trustworthiness of the node cluster with respect to securely training the AI model.

13. The apparatus of claim 8, further comprising determining, based on the indication of the AI model and the current state information, a knowledge network topology for use in training the AI model, the knowledge network topology indicating selected node clusters of the plurality of node clusters of the network which are useful in training the AI model, and interconnections between the selected node clusters, the interconnections indicating significance of relationships between data at the selected node clusters, the significance and the relationships being specific to training for the AI model as specified by the indication of the AI model.

14. The apparatus of claim 8, further configured to:
determine a requirement for one of the node clusters in the sequence to use specified data, currently unavailable at said one of the node clusters, for training the AI model; and
cause another node cluster of the network to forward the specified data to said one of the node clusters in the sequence, in time for said one of the node clusters to train the AI model using the specified data.

15. The apparatus of claim 8, wherein the current state information is maintained and kept up to date in a database which is local to or remote from a network node cluster at which the apparatus is located.

16. The apparatus of claim 8, wherein the sequence includes one node cluster or multiple node clusters, a number of node clusters in the sequence being configured based at least in part on a rate of change of the current state information.

17. The apparatus of claim 8, wherein the apparatus is deployed at one of the plurality of node clusters which receives the AI model, or wherein the apparatus is separate from some or all of the plurality of node clusters which receive the AI model.

18. A method comprising, by an apparatus in a knowledge sharing network:
receiving an indication of an artificial intelligence (AI) model for training at node clusters in the network;
obtaining training requirements for the AI model;
obtaining current state information for the network, including for each node cluster of a plurality of the node clusters in the network, the current state information indicative of a current capability for training the AI model using resources at the node cluster, the current state information indicative of characteristics of AI model training data available using the node cluster;
based on the indication of the AI model, the training requirements and the current state information, determining a route traversing a sequence of the plurality of node clusters, each node cluster in the sequence to be used in turn for sequential training of the AI model using respective resources and data available thereto, as the AI model is forwarded along the route; and
causing forwarding of the AI model to a next node cluster in the sequence according to the route.

19. The method of claim 18, wherein each node cluster of the plurality of node clusters is a respective single node of the network or a respective plurality of nodes of the network.

20. The method of claim 18, further comprising:
obtain training requirements for training the AI model,
wherein determining the route traversing the sequence of the plurality of node clusters is based further on the training requirements.
